(19) United States
(12) Patent Application Publication
(10) Pub. No.: US 2013/0325596 A1
(43) Pub. Date: Dec. 5, 2013

(54) Commerce System and Method of Price Optimization using Cross Channel Marketing in Hierarchical Modeling Levels

(71) Applicant: Kenneth J. Ouimet, Scottsdale, AZ (US)

(72) Inventor: Kenneth J. Ouimet, Scottsdale, AZ (US)

(21) Appl. No.: 13/487,065

(22) Filed: Jun. 1, 2012

(51) Int. Cl. G06Q 30/02

(52) U.S. Cl. 705/14.48

(57) ABSTRACT

A commerce system has retailers offering products for sale to consumers. A product is evaluated for marketing through a first marketing channel at a first modeling level. The product is evaluated for marketing through a second marketing channel at the first modeling level. A cross channel performance of the marketing of the product through the first marketing channel and second marketing channel is optimized at a second modeling level higher than the first modeling level. The commerce system is controlled by allocating resources to the first marketing channel and second marketing channel based on the cross channel performance of the first marketing channel and second marketing channel. A plurality of attributes of the product can be evaluated at a plurality of hierarchical modeling levels. The evaluations of the product from the hierarchical modeling levels are combined to optimize commercialization of the product for a member of the commerce system.

### FIELD OF THE INVENTION

The present invention relates in general to consumer purchasing and, more particularly, to a commerce system and method of price optimization using cross channel marketing in hierarchical modeling levels.

### BACKGROUND OF THE INVENTION

Economic and financial modeling and planning is commonly used to estimate or predict the performance and outcome of real systems, given specific sets of input data of interest. An economic-based system will have many variables and influences which determine its behavior. A model is a mathematical expression or representation, which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system, which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

Economic modeling has many uses and applications. One area in which modeling has been applied is in the retail environment. Grocery stores, general merchandise stores, specialty shops, and other retail outlets face stiff competition for limited consumers and business. In the face of mounting competition and high expectations from investors, retailers must look for every advantage they can muster in maximizing market share, sales, revenue, and profit. Economic modeling can be an effective tool in helping store owners and managers forecast and optimize business decisions. The retailer operates under a business plan to set pricing, order inventory, formulate and run promotions, add and remove product lines, organize product shelving and displays, select signage, hire employees, expand stores, collect and maintain historical sales data, evaluate performance and trends, and make strategic decisions. Based on economic modeling, the retailer can change the business plan as needed.

One purpose of economic modeling is to develop a marketing plan for the retailer. A traditional mass marketing approach commonly employs a one-price-fits-all marketing strategy. The retailer puts out an advertisement to the general public, e.g., newspaper ad for a sale or discounted price on a product. Anyone and everyone that responds to the advertisement can purchase the product at the stated advertised sale price. The traditional mass marketing approach has an advantage with the economies of scale that can be realized through mass production, distribution, and communication. Yet, there is little or no feedback as to the success or performance of the mass marketing campaign. The retailer often cannot determine how many consumers actually made a purchase decision as a result of responding to the advertisement. The consumer may have selected the item for purchase with no prior knowledge of the advertisement, i.e., the published advertisement was not the catalyst for bring the consumer into the retailer. Alternatively, the consumer might have purchased the item without a discount. The consumer will of course accept the discounted price, but would have paid regular price. In some cases, the retailer is unnecessarily foregoing profit by discounting the product to the general public.

Marketing segmentation involves identifying and targeting specific market segments that are more likely to be interested in purchasing the retailer's products. Mass marketing generally does not lend itself to focused market segmentation, other than possibly the type of publication and geographic area where the advertisement is published. If the newspaper is a local fitness publication made available outside certain stores, then primarily only the consumers with an interest in fitness who might pick up the fitness publication will see the advertisement. Nonetheless, every fitness oriented consumer who acts on the advertisement receives the same sale or discounted price on the product.

Retailers use a variety of marketing strategies to increase sales, revenue, and profit. Common marketing strategies include mass marketing, in-store sale pricing, and on-line sale pricing. Each marketing strategy is separately modeled and evaluated according the retailer's business plan. The modeling outcomes of each marketing strategy are typically independent and isolated. For example, the in-store sale pricing model has little or no correspondence to the on-line sale pricing model. The business operations for in-store marketing activities are often handled by a separate person or department of the retailer than the on-line marketing activities. The separate modeling makes allocation of the overall marketing budget to the various marketing activities difficult to manage and execute. The retailer usually selects budget allocations to each marketing activity based on general business objectives and each person or department handling a separate marketing activity uses the budget allocation accordingly.

In a highly competitive market, the profit margin is paper thin and consumers and products are becoming more differentiated. Consumers are often well informed through electronic media and will have appetites only for specific products. Retailers must understand and act upon the market segment which is tuned into their niche product area to make effective use of marketing dollars. The traditional mass marketing approach using gross market segmentation is insufficient to accurately predict consumer behavior across the various market segments. The retailers remain motivated to optimize marketing strategy, particularly pricing strategy, to maximize profit and revenue.

### SUMMARY OF THE INVENTION

A need exists for retailers to build market share and increase sales and revenue in a manner that maximizes profit or other business objective. Accordingly, in one embodiment, the present invention is a method of controlling a commerce system comprising the steps of providing an enterprise level marketing budget, modeling allocation of a first portion of the enterprise level marketing budget to market a product through a first marketing channel, modeling allocation of a second portion of the enterprise level marketing budget to market the product through a second marketing channel, evaluating the marketing of the product through the first marketing channel or second marketing channel, adjusting the first portion or second portion of the enterprise level marketing budget to optimize the marketing of the product, and controlling the commerce system by allocating the first portion of the enterprise level marketing budget to the first marketing channel and the second portion of the enterprise level marketing budget to the second marketing channel to optimize the marketing of the product.

In another embodiment, the present invention is a method of controlling a commerce system comprising the steps of providing a marketing budget, providing a product, evaluating marketing of the product through a first marketing channel at a first modeling level in accordance with the marketing budget, evaluating marketing of the product through a second marketing channel at the first modeling level in accordance with the marketing budget, and optimizing cross channel performance of the marketing of the product through the first marketing channel and second marketing channel at a second modeling level.

In another embodiment, the present invention is a method of controlling a commerce system comprising the steps of providing a marketing budget, providing a product, evaluating marketing of the product through a first marketing channel in accordance with the marketing budget, evaluating marketing of the product through a second marketing channel in accordance with the marketing budget, and optimizing cross channel performance of the marketing of the product through the first marketing channel and second marketing channel.

In another embodiment, the present invention is a computer program product usable with a programmable computer processor having a computer readable program code embodied in a tangible computer usable medium for controlling a commerce system comprising the steps of providing a marketing budget, providing a product, evaluating marketing of the product through a first marketing channel at a first modeling level in accordance with the marketing budget, evaluating marketing of the product through a second marketing channel at the first modeling level in accordance with the marketing budget, and optimizing cross channel performance of the marketing of the product through the first marketing channel and second marketing channel at a second modeling level.

### BRIEF DESCRIPTION OF THE DRAWINGS

FIG. 1 illustrates a retailer engaged in commercial activity with a consumer;

FIG. 2 illustrates a commerce system with a manufacturer, distributor, retailer, and consumer;

FIG. 3 illustrates commercial transactions between consumers and retailers with the aid of a retailer service provider;

FIG. 4 illustrates an electronic communication network between members of the commerce system;

FIG. 5 illustrates a computer system operating with the electronic communication network;

FIG. 6 illustrates a consumer profile registration webpage with the retailer service provider;

FIG. 7 illustrates a consumer login webpage for the retailer service provider;

FIG. 8 illustrates a webpage with preference levels for product attributes defined by the consumer and entered into a personal assistant engine;

FIG. 9 illustrates commercial interaction between the consumers, retailers, and retailer service provider to generate a shopping list with discount offers;

FIG. 10 illustrates optimization of the shopping list with individualized discounted offers;

FIGS. 11a-11b illustrate curves of price versus demand;

FIG. 12 illustrates collecting product information from retailer websites directly by the retailer service provider or indirectly using consumer computers;

FIG. 13 illustrates comparison of consumer weighted product attributes and retailer product information;

FIG. 14 illustrates generation of an individualized discount for a specific consumer;

FIG. 15 illustrates a consumer on the premises of a retailer;

FIG. 16 illustrates the consumer receiving in-store mobile pricing information by cell phone;

FIG. 17 illustrates a plurality of marketing channels providing marketing information to a consumer to patronize a retailer;

FIG. 18 illustrates hierarchical cross channel modeling of the marketing channels and accumulation of outcomes at an enterprise level;

FIG. 19 illustrates hierarchical modeling using marketing channels, product attributes, and business strategies;

FIG. 20 illustrates a process of controlling the commerce system by allocating portions of an enterprise level marketing budget to different marketing channels;

FIG. 21 illustrates a process of controlling the commerce system by allocating resources to different marketing channels; and

FIG. 22 illustrates a process of controlling the commerce system by modeling product attributes over multiple modeling levels.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Economic and financial modeling and planning are important business tools that allow companies to conduct business planning, forecast demand, and optimize prices and promotions to meet profit and/or revenue goals. Economic modeling is applicable to many businesses, such as manufacturing, distribution, wholesale, retail, medicine, chemicals, financial markets, investing, exchange rates, inflation rates, pricing of options, value of risk, research and development, and the like.

In the face of mounting competition and high expectations from investors, most, if not all, businesses must look for every advantage they can muster in maximizing market share and profits. The ability to forecast demand, in view of pricing and promotional alternatives, and to consider other factors which materially affect overall revenue and profitability is vital to the success of the bottom line, and the fundamental need to not only survive but to prosper and grow.

In particular, economic modeling is essential to businesses that face thin profit margins, such as general consumer merchandise and other retail outlets. Many businesses are interested in economic modeling and forecasting, particularly when the model provides a high degree of accuracy or confidence. Such information is a powerful tool and highly valuable to the business. While the present discussion will involve a retailer, it is understood that the system described herein is applicable to data analysis for other members in the chain of commerce, or other industries and businesses having similar goals, constraints, and needs.

A retailer routinely collects T-LOG sales data for most if not all products in the normal course of business. Using the T-LOG data, the system generates a demand model for one or more products at one or more stores. The model is based upon the T-LOG data for that product and includes a plurality of parameters. The values of the parameters define the demand model and can be used for making predictions about the future sales activity for the product. For example, the model for each product can be used to predict future demand or sales of the product at that store in response to a proposed price, associated promotions or advertising, as well as impact from holidays and local seasonal variations. Promotion and advertising increase consumer awareness of the product.

An economic demand model analyzes historical retail T-LOG sales data to gain an understanding of retail demand as a function of factors such as price, promotion, time, consumer, seasonal trends, holidays, and other attributes of the transaction. The demand model can be used to forecast future demand by consumers as measured by unit sales. Unit sales are typically inversely related to price, i.e., the lower the price, the higher the sales. The quality of the demand model—and therefore the forecast quality—is directly affected by the quantity, composition, and accuracy of historical T-LOG sales data provided to the model.

The retailer makes business decisions based on forecasts. The retailer orders stock for replenishment purposes and selects items for promotion or price discount. To support good decisions, it is important to quantify the quality of each forecast. The retailer can then review any actions to be taken based on the accuracy of the forecasts on a case-by-case basis.

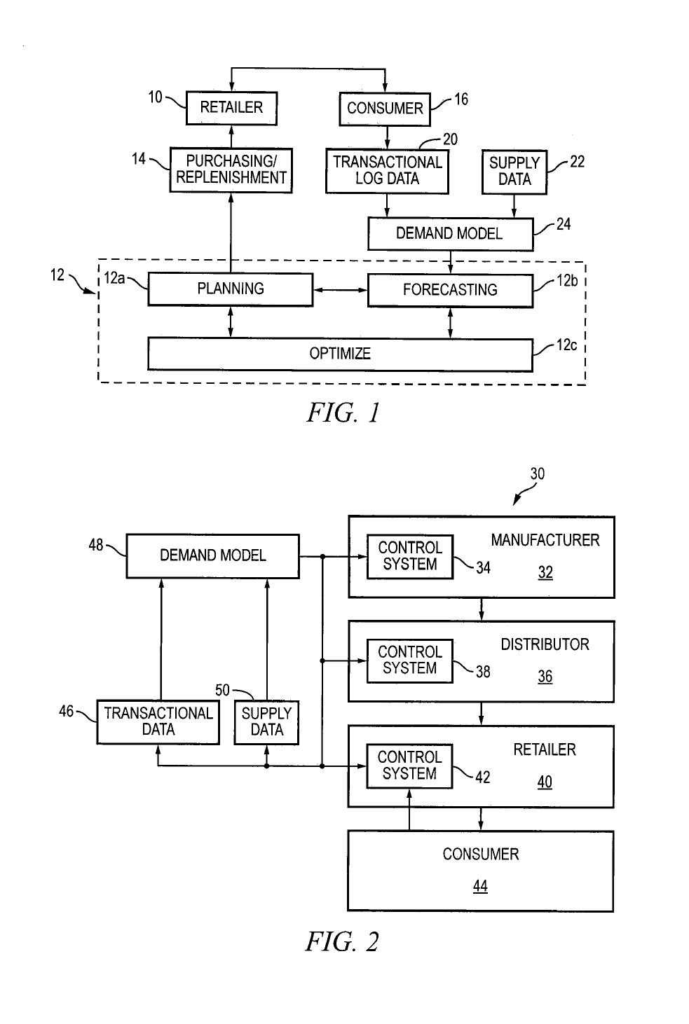

Referring to FIG. 1, retailer 10 has certain product lines or services available to consumers as part of its business plan 12. The terms products and services are interchangeable in the commerce system. Retailer 10 can be a food store chain, general consumer product retailer, drug store, discount warehouse, department store, apparel store, specialty store, or service provider. Retailer 10 has the ability to set pricing, order inventory, run promotions, arrange its product displays, collect and maintain historical sales data, and adjust its strategic business plan.

Business plan 12 includes planning 12a, forecasting 12b, and optimization 12c steps and operations. Business plan 12 gives retailer 10 the ability to evaluate performance and trends, make strategic decisions, set pricing, order inventory, formulate and run promotions, hire employees, expand stores, add and remove product lines, organize product shelving and displays, select signage, and the like. Business plan 12 allows retailer 10 to analyze data, evaluate alternatives, run forecasts, and make decisions to control its operations. With input from the planning 12a, forecasting 12b, and optimization 12c steps and operations of business plan 12, retailer 10 undertakes various purchasing or replenishment operations 14. Retailer 10 can change business plan 12 as needed.

Retailer 10 routinely enters into sales transactions with customer or consumer 16. In fact, retailer 10 maintains and updates its business plan 12 to increase the number of transactions (and thus revenue and/or profit) between retailer 10 and consumer 16. Consumer 16 can be a specific individual, account, or business entity.

For each sales transaction entered into between retailer 10 and consumer 16, information describing the transaction is stored in T-LOG 20. When a consumer goes through the check-out at a grocery or any other retail store, each of the items to be purchased is scanned and data is collected and stored by a point-of-sale (POS) system, or other suitable data collection and storage system, in T-LOG 20. The data includes the then current price, promotion, and merchandizing information associated with the product along with the units purchased, and the dollar sales. The date and time, and store and consumer information corresponding to that purchase are also recorded.

T-LOG data 20 contains one or more line items for each retail transaction, such as those shown in Table 1. Each line item includes information or attributes relating to the transaction, such as store number, product number, time of transaction, transaction number, quantity, current price, profit, promotion number, and consumer identity or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 20 is accurate, observable, and granular product information based on actual retail transactions within the store. T-LOG data 20 represents the known and observable results from the consumer buying decision or process. T-LOG data 20 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.60 | 0.05 | PROMO2 | C1 |
| S1 | P3 | D1 | T1 | 3 | 3.00 | 0.40 | PROMO3 | C1 |
| S1 | P4 | D1 | T2 | 4 | 1.60 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T4 | 5 | 1.50 | 0.20 | PROMO1 | C4 |
| S2 | P7 | D3 | T5 | 1 | 5.00 | 1.10 | PROMO5 | C5 |
| S2 | P1 | D3 | T6 | 2 | 1.50 | 0.20 | PROMO1 | C6 |
| S2 | P8 | D3 | T6 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.60 each and three products P3 at price $3.00 each. In transaction T2 on day/time D1, consumer C2 has four products P4 at price $1.60 each and one product P5 at price $2.25. In transaction T3 on day/time D1, consumer C3 has ten products P6 at $2.65 each in his or her basket. In transaction T4 on day/time D2 (different day and time) in store S1, consumer C4 purchases five products P1 at price $1.50 each. In store S2, transaction T5 with consumer C5 on day/time D3 (different day and time) involves one product P7 at price $5.00. In store S2, transaction T6 with consumer C6 on day/time D3 involves two products P1 at price $1.50 each and one product P8 at price $3.30.

Table 1 further shows that product P1 in transaction T1 has promotion PROM01. PROM01 can be any suitable product promotion such as a front-page featured item in a local advertising flyer. Product P2 in transaction T1 has promotion PROMO2 as an end-cap display in store S1. Product P3 in transaction T1 has promotion PROM03 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROM04 as a volume discount for 10 or more items. Product P7 in transaction T5 on day/time D3 has promotion PROM05 as a $0.50 rebate. Product P8 in transaction T6 has no promotional offering. A promotion may also be classified as a combination of promotions, e.g., flyer with sale price, end-cap with rebate, or discounted offer as described below.

Retailer 10 may also provide additional information to T-LOG data 20 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 20.

Supply data 22 is also collected and recorded from manufacturers and distributors. Supply data 22 includes inventory or quantity of products available at each location in the chain of commerce, i.e., manufacturer, distributor, and retailer. Supply data 22 includes product on the store shelf and replenishment product in the retailer's storage area.

With T-LOG 20 and supply data 22 collected, various suitable methods or algorithms can be used to analyze the data and form demand model 24. Model 24 may use a combination of linear, nonlinear, deterministic, stochastic, static, or dynamic equations or models for analyzing T-LOG 20 or aggregated T-LOG data and supply data 22 and making predictions about consumer behavior to future transactions for a particular product at a particular store, or across entire product lines for all stores. Model 24 is defined by a plurality of parameters and can be used to generate unit sales forecasting, price optimization, promotion optimization, markdown/clearance optimization, assortment optimization, merchandize and assortment planning, seasonal and holiday variance, and replenishment optimization. Model 24 has a suitable output and reporting system that enables the output from model 24 to be retrieved and analyzed for updating business plan 12.

In FIG. 2, a commerce system 30 is shown involving the movement of goods between members of the system. Manufacturer 32 produces goods in commerce system 30. Manufacturer 32 uses control system 34 to receive orders, control manufacturing and inventory, and schedule deliveries. Distributor 36 receives goods from manufacturer 32 for distribution within commerce system 30. Distributor 36 uses control system 38 to receive orders, control inventory, and schedule deliveries. Retailer 40 receives goods from distributor 36 for sale within commerce system 30. Retailer 40 uses control system 42 to place orders, control inventory, and schedule deliveries with distributor 36. Retailer 40 sells goods to consumer 44. Consumer 44 patronizes retailer's establishment either in person or using on-line ordering. The consumer purchases are entered into control system 42 of retailer 40 as T-LOG data 46.

The purchasing decisions made by consumer 44 drive the manufacturing, distribution, and retail portions of commerce system 30. More purchasing decisions made by consumer 44 for retailer 40 lead to more merchandise movement for all members of commerce system 30. Manufacturer 32, distributor 36, and retailer 40 utilize demand model 48 (similar to model 24), via respective control systems 34, 38, and 42, to control and optimize the ordering, manufacturing, distribution, sale of the goods, and otherwise execute respective business plan 12 within commerce system 30 in accordance with the purchasing decisions made by consumer 44.

Manufacturer 32, distributor 36, and retailer 40 provide historical T-LOG 46 and supply data 50 to demand model 48 by electronic communication link, which in turn generates forecasts to predict the need for goods by each member and control its operations. In one embodiment, each member provides its own historical T-LOG data 46 and supply data 50 to demand model 48 to generate a forecast of demand specific to its business plan 12. Alternatively, all members can provide historical T-LOG data 46 and supply data 50 to demand model 48 to generate composite forecasts relevant to the overall flow of goods. For example, manufacturer 32 may consider a proposed discounted offer, rebate, promotion, seasonality, or other attribute for one or more goods that it produces. Demand model 48 generates the forecast of sales based on available supply and the proposed price, consumer, rebate, promotion, time, seasonality, or other attribute of the goods. The forecast is communicated to control system 34 by electronic communication link, which in turn controls the manufacturing process and delivery schedule of manufacturer 32 to send goods to distributor 36 based on the predicted demand ultimately determined by the consumer purchasing decisions. Likewise, distributor 36 or retailer 40 may consider a proposed discounted offer, rebate, promotion, or other attributes for one or more goods that it sells. Demand model 48 generates the forecast of demand based on the available supply and proposed price, consumer, rebate, promotion, time, seasonality, and/or other attribute of the goods. The forecast is communicated to control system 38 or control system 42 by electronic communication link, which in turn controls ordering, distribution, inventory, and delivery schedule for distributor 36 and retailer 40 to meet the predicted demand for goods in accordance with the forecast.

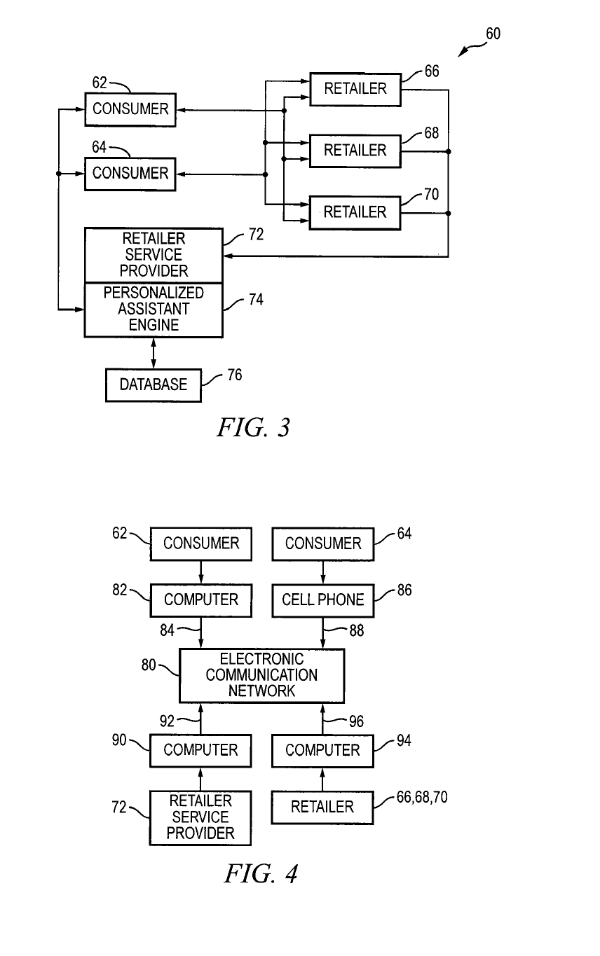

FIG. 3 illustrates a commerce system 60 with consumers 62 and 64 engaged in purchasing transactions with retailers 66, 68, and 70. Retailers 66-70 are supplied by manufacturers and distributors, as described in FIG. 2. Retailers 66-70 are typically local to consumers 62-64, i.e., retailers that the consumers will likely patronize. Retailers 66-70 can also be remote from consumers 62-64 with transactions handled by electronic communication medium, e.g., phone or on-line website via personal computer, and delivered electronically or by common carrier, depending on the nature of the goods. Consumers 62-64 patronize retailers 66-70 by selecting one or more items for purchase from one or more retailers. For example, consumer 62 can visit the store of retailer 66 in person and select product P1 for purchase. Consumer 62 can contact retailer 68 by phone or email and select product P2 for purchase. Consumer 64 can browse the website of retailer 70 using a personal computer and select product P3 for purchase. Accordingly, consumers 62-64 and retailers 66-70 regularly engage in commercial transactions within commerce system 60.

A retailer service provider 72 is a part of commerce system 60. Retailer service provider 72 is a third party that in part assists consumers 62-64 with the product evaluation and purchasing decision process by providing access to a comparative shopping service. More specifically, retailer service provider 72 operates and maintains personal assistant engine 74 that prioritizes product attributes and optimizes product selection according to consumer-weighted preferences. The product attributes and consumer-weighted preferences are stored in database 76. In addition, personal assistant engine 74 generates an individualized discounted offer for a product to entice a positive purchasing decision by a specific consumer. Personalized assistant engine 74 saves the consumer considerable time and money by providing access to a comprehensive, reliable, and objective comparative shopping service.

As described herein, manufacturer 32, distributor 36, retailers 66-70, consumers 62-64, and retailer service provider 72 are considered members of commerce system 60. The retailer generally refers to the seller of the product and consumer generally refers to the buyer of the product. Depending on the transaction within commerce system 60, manufacturer 32 can be the seller and distributor 36 can be the buyer, or distributor 36 can be the seller and retailers 66-70 can be the buyer, or manufacturer 32 can be the seller and consumers 62-64 can be the buyer.

Each consumer goes through a product evaluation and purchasing decision process each time a particular product is selected for purchase. Some product evaluation and purchasing decision processes are simple and routine. For example, when consumer 62 is conducting weekly shopping in the grocery store, the consumer considers a needed item or item of interest, e.g., canned soup. Consumer 62 may have a preferred brand, size, and flavor of canned soup. Consumer 62 selects the preferred brand, size, and flavor sometimes without consideration of price, places the item in the basket, and moves on. The product evaluation and purchasing decision process can be almost automatic and instantaneous but nonetheless still occurs based on prior experiences and preferences. Consumer 62 may pause during the product evaluation and purchasing decision process and consider other canned soup options. Consumer 62 may want to try a different flavor or another brand offering a lower price. As the price of the product increases, the product evaluation and purchasing decision process usually becomes more involved. If consumer 62 is shopping for a major appliance, the product evaluation and purchasing decision process may include consideration of several manufacturers, visits to multiple retailers, review of features and warranty, talking to salespersons, reading consumer reviews, and comparing prices. In any case, understanding the consumer's approach to the product evaluation and purchasing decision process is part of an effective comparative shopping service. The comparative shopping service assists the consumer in finding the optimal price and product attributes, e.g., brand, quality, quantity, size, features, ingredients, service, warranty, and convenience, that are important to the consumer and tip the purchasing decision toward selecting a particular product and retailer.

Personal assistant engine 74 can be made available to consumers 62-64 via computer-based on-line website or other electronic communication medium, e.g., wireless cell phone or other personal communication device. FIG. 4 shows an electronic communication network 80 for transmitting information between consumers 62-64, retailer service provider 72, and retailers 66-70. Consumer 62 operating with computer 82 is connected to electronic communication network 80 by way of communication channel or link 84. Likewise, consumer 64 operating with a cellular telephone, smart phone, or other wireless communication device 86, is connected to electronic communication network 80 by way of communication channel or link 88. Retailer service provider 72 uses computer 90 to communicate with electronic communication network 80 over communication channel or link 92. Retailers 66-70 use computer 94 to communicate with electronic communication network 80 over communication channel or link 96. The electronic communication network 80 is a distributed network of interconnected routers, gateways, switches, and servers, each with a unique internet protocol (IP) address to enable communication between individual computers, cellular telephones, electronic devices, or nodes within the network. In one embodiment, communication network 80 is a global, open-architecture network, commonly known as the Internet. Alternatively, electronic communication network 80 is a cell phone service network. Communication channels 84, 88, 92, and 96 are bi-directional and transmit data between computers 82, 90, and 94 and cell phone 86 and electronic communication network 80 in a hard-wired or wireless configuration. For example, computers 82, 90, and 94 have email, texting, and Internet capability, and cell phone 86 has email, mobile applications (apps), texting, and Internet capability.

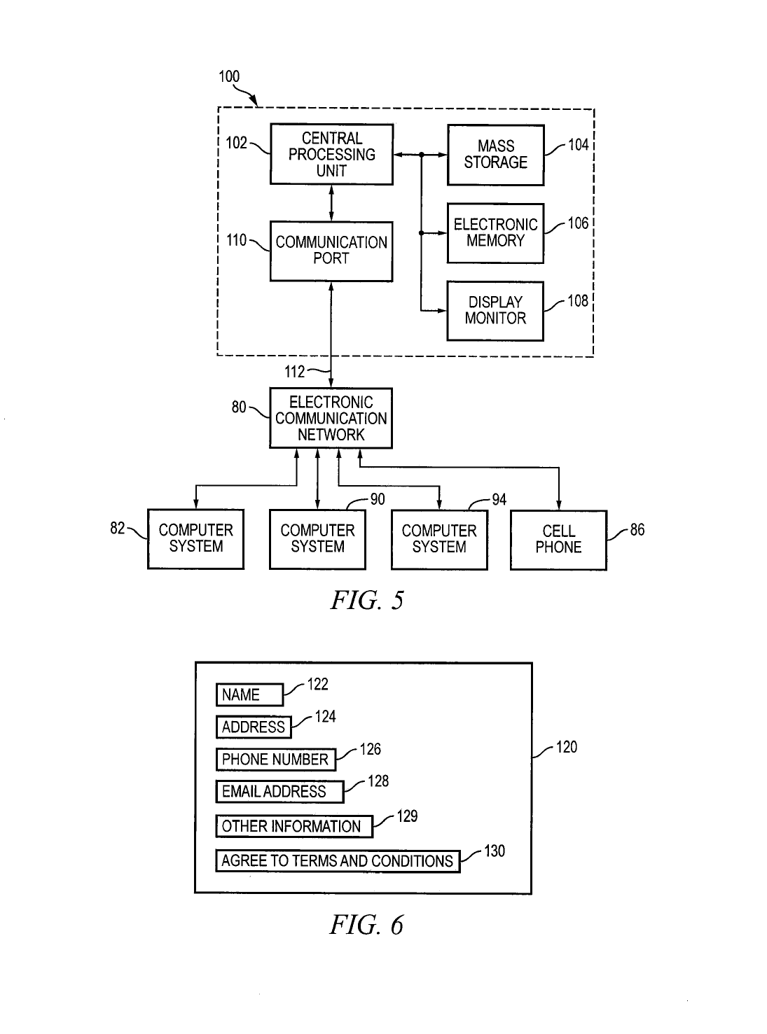

Further detail of the computer systems used in electronic communication network 80 is shown in FIG. 5 as a simplified computer system 100 for executing the software program used in the electronic communication process. Computer system 100 is a general purpose computer including a processing unit or microprocessor 102, mass storage device or hard disk 104, electronic memory 106, display monitor 108, and communication port 110. Communication port 110 represents a modem, high-speed Ethernet link, wireless, or other electronic connection to transmit and receive input/output (I/O) data over communication link 112 to electronic communication network 80. Computer system or server 82, 90, and 94 can be configured as shown for computer 100. Computer system 82, 90, 94, and 100 and cell phone 86 transmit and receive information and data over communication network 80.

Computer systems 82, 90, 94, and 100 can be physically located in any location with access to a modem or communication link to network 80. For example, computer 82, 90, 94, and 100 can be located in a home or business office. Retailer service provider 72 may use computer system 82, 90, 94, or 100 in its business office. Alternatively, computer 82, 90, 94, and 100 can be mobile and follow the user to any convenient location, e.g., remote offices, consumer locations, hotel rooms, residences, vehicles, public places, or other locales with electronic access to electronic communication network 80. The consumer can access electronic communication network 80 by mobile app operating in cell phone 86.

Each of the computers runs application software and computer programs, which can be used to display user interface screens, execute the functionality, and provide the electronic communication features as described below. The application software includes an Internet browser, local email application, mobile apps, word processor, spreadsheet, and the like. In one embodiment, the screens and functionality come from the application software, i.e., the electronic communication runs directly on computer system 82, 90, 94, and 100. Alternatively, the screens and functions are provided remotely from one or more websites on servers within electronic communication network 80.

The software is originally provided on computer readable media, such as compact disks (CDs), external drive, or other mass storage medium. Alternatively, the software is downloaded from electronic links, such as the host or vendor website. The software is installed onto the computer system hard drive 104 and/or electronic memory 106, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a computer program medium. Computers 82, 90, 94, and 100 run application software to execute instructions for communication between consumers 62 and 64 and retailer service provider 72 to perform the functions described herein. Cell phone 86 runs one or more mobile apps to execute instructions for communication between consumers 62 and 64 and retailer service provider 72. The application software is an integral part of the control of commercial activity within commerce system 60.

To interact with retailer service provider 72, consumers 62 and 64 first create an account and profile with the retailer service provider by electronic links 84 and 88. Consumers 62 and 64 can use some features offered by retailer service provider 72 without creating an account, but full access requires completion of a registration process. The consumer accesses website 120 operated by retailer service provider 72 on computer systems 82, 90, 94, or 100 and provides data to complete the registration and activation process, as shown in FIG. 6. The consumer can access website 120 using cell phone 86 or computer systems 82, 90, 94, or 100 by typing the uniform resource locator (URL) for website 120, or by clicking on a banner located on another website which re-directs the consumer to a predetermined landing page for website 120. The data provided by the consumer to retailer service provider 72 may include name in block 122, home address and work address with zip code in block 124, phone number in block 126, email address in block 128, and other information and credentials in block 129 necessary to establish a profile, identity, and general preferences for the consumer. The consumer's home and work address and zip code are important as shopping is often a local activity. The consumer agrees to the terms and conditions of conducting electronic communication through retailer service provider 72 in block 130.

The profile can also contain information related to the shopping habits and preferences of consumers 62-64. For example, the other information in block 129 includes product preferences, consumer characteristics, and consumer demographics, e.g., gender, age, family size, age of children, occupation, medical conditions, shopping budget, and general product preferences (low fat, high fiber, vegetarian, natural with no preservatives, biodegradable, convenience of preparation or use, name brand, generic brands, kosher). Consumers 62-64 can specify preferred retailers and spending patterns. Alternatively, retailers 66-70 can provide T-LOG data 46 to retailer service provider 72 to accurately track the shopping patterns of consumers 62-64. Consumer service provider 72 will have records of consumer loyalty and value to each retailer. Consumer value is based on spending patterns of the consumer.

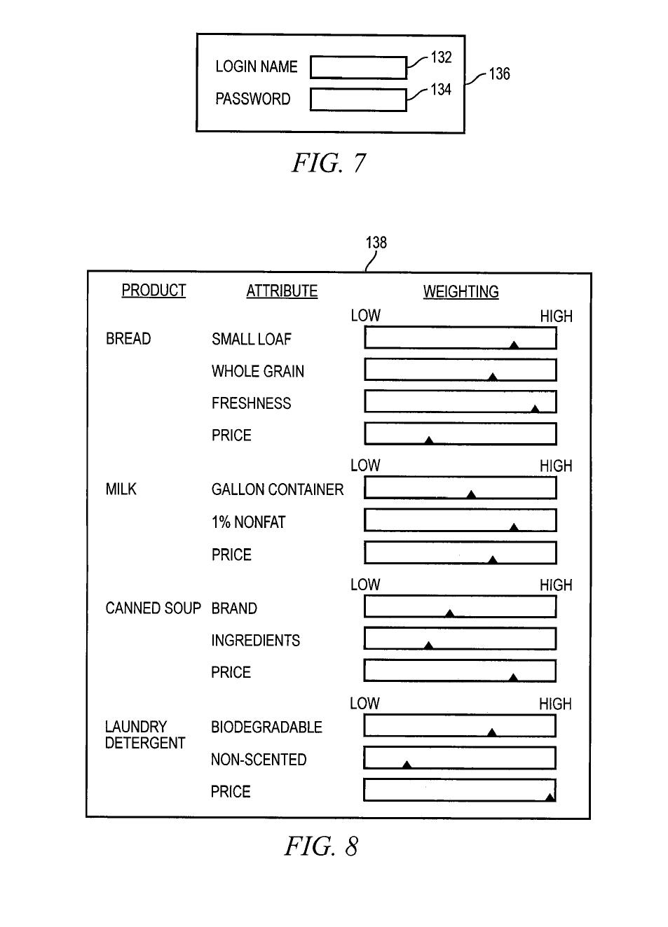

The consumer's profile is stored and maintained within database 76. The consumer can access and update his or her profile or interact by entering login name 132 and password 134 in webpage 136, as shown in FIG. 7. The consumer name can be any personal name, user name, number, or email address that uniquely identifies the consumer and the password can be assigned to or selected by the consumer. Accordingly, the consumer's profile and personal data remain secure and confidential within database 76 by retailer service provider 72.

Once logged-in to retailer service provider 72, consumers 62 and 64 utilize personal assistant engine 74 to assist with the shopping process. More specifically, consumers 62 and 64 provide commonly purchased products or anticipated purchase products through webpage 138, as shown in FIG. 8. Each product will have product attributes weighted by consumer preference. Webpage 138 can display a list of available product attributes associated with each product category. The available product attributes can be product-specific attributes, diet/health/nutrient related product attributes, lifestyle related product attributes, environment related product attributes, allergen related product attributes, and social/society related product attributes. The product-specific attributes can include brand, ingredients, size, price, freshness, warranty, and the like. The consumer defines the products, adds one or more product attributes, and assigns weighted preferences with a sliding scale from 0 (lowest importance) to 9 (highest importance). For example, the consumer may define the products of interest as bread, milk, canned soup, and laundry detergent. The consumer adds product attributes for each product and, using a sliding scale, assigns a preference level for each product attribute, as shown in webpage 138. The sliding scale adjusts the preference level of the product attribute by dragging a pointer along the length of the sliding scale. In the present example, the consumer preference levels for bread attributes are 7 for small loaf, 6 for whole grain, 8 for freshness, and 3 for price. The consumer preference levels for milk attributes are 5 for gallon container, 7 for 1% low fat, and 6 for price. The consumer preference levels for canned soup attributes are 4 for brand, 3 for product ingredients, and 7 for price. The consumer preference levels for laundry detergent attributes are 6 for biodegradable, 2 for non-scented, and 9 for price.

The consumer can also identify a specific preferred retailer as an attribute with an assigned preference level based on convenience and personal experience. The consumer may assign value to shopping with a specific retailer because of specific products offered by that store, familiarity with the store layout, good retailer service experiences, or location that is convenient on the way home from work, picking up the children from school, or routine weekend errand route.

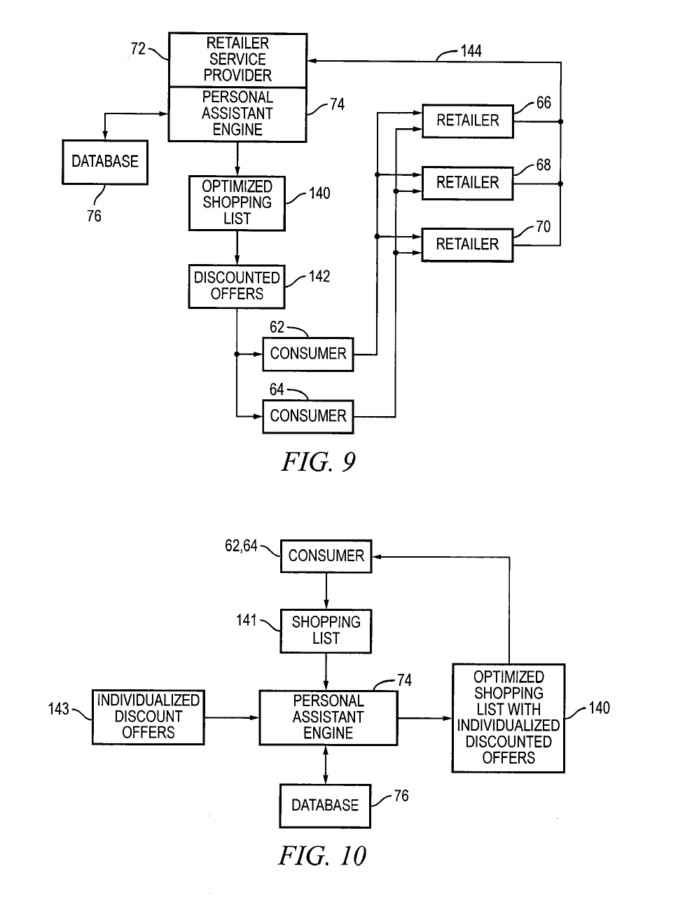

Personal assistant engine 74 stores the consumer-defined products and attributes from webpage 138 for future reference and updating. Personal assistant engine 74 can also store prices, product descriptions, names and locations of the retail stores selling the products, offer histories, purchase histories, as well as various rules, policies and algorithms in database 76. Given the consumer generated shopping list from webpage 138, personal assistant engine 74 executes a consumer model or comparative shopping service to generate an optimized shopping list 140 that suggests which products should be purchased from which retailers on which day to maximize the value to the consumer as defined by the consumer profile and list of products of interest with weighted attributes. Personal assistant engine 74 generates for each specific consumer a discounted offer 142 for one or more products on optimized shopping list 140, as shown in FIG. 9. The discounted offer can be a default discount offer or crafted for each individual “one-to-one” consumer based on a product specific preference value of the consumer weighted attributes, see further discussion below. That is, optimized shopping list 140 for consumer 62 will have an individualized discounted offer for product P1 based on the product specific preference value of the consumer 62 weighted attributes. The optimized shopping list 140 for consumer 64 may have a different individualized discounted offer for the same product P1 based on the product specific preference value of the consumer 64 weighted attributes.

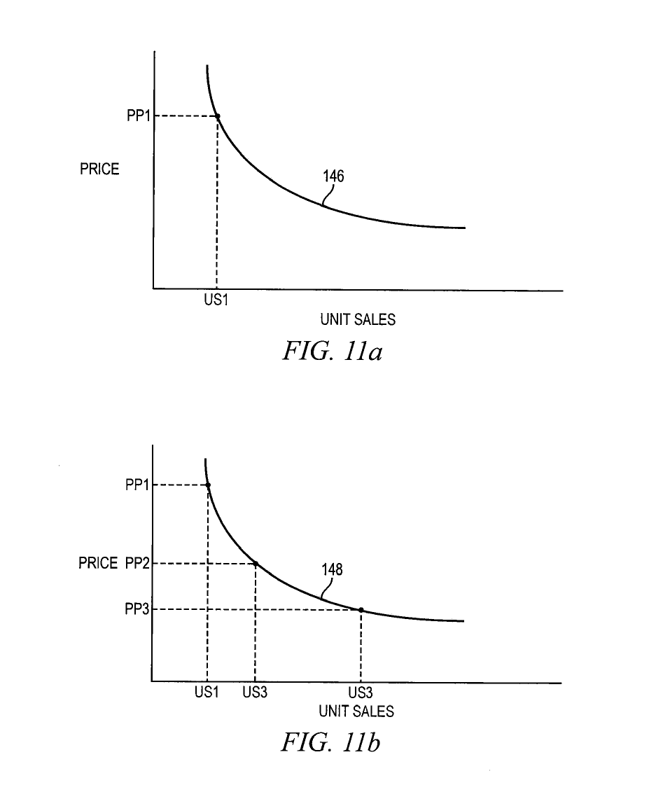

FIG. 10 shows further detail of personal assistant engine 74 generating optimized shopping list 140 based on shopping list 141 created by consumer 62 in webpage 138, product information from database 76, and individualized discounted offers 143. The individualized discounted offer 143 should be set to trigger a positive purchasing decision for each consumer. The products that show up on optimized shopping list 140 are the products of interest to the consumer offered at the most valued price. The individual products in optimized shopping list 140 can be added or deleted and the weighted product attributes can be changed by the consumer. The optimized shopping list 140 and individualized discounted offers 143 are specific for each consumer and allow retailer service provider 72 to track specific products and preferred retailers selected by the consumer.

In the business transactions between consumers 62-64 and retailers 66-70, retailer service provider 72 plays an important role in terms of increasing sales for the retailer, while providing the consumer with the most value for the money, i.e., creating a win-win scenario. More specifically, retailer service provider 72 operates as an intermediary between special offers and discounts made available by the retailer and distribution of those individualized offers to the consumers.

To explain the role of retailer service provider 72, first consider demand curve 146 of price versus unit sales, as shown in FIG. 11a. In demand curve 146 for a given product P, as price increases, unit sales decrease and, conversely, as price decreases, unit sales increase. At price point PP1, the unit sales are US1. The revenue attained by the retailer is given as PP1*US1. Thus, using a conventional mass marketing strategy as described in the background, if the retailer offers an across the board discounted offer or sale price PP1 to all consumers, e.g., via a newspaper advertisement, then, according to demand curve 146, the expected unit sales will be US1 and the retailer revenue is PP1*US1. That is, those consumers with a purchasing decision threshold of PP1 will buy product P and those consumers with a purchasing decision threshold less than PP1 will not buy product P. The conventional mass marketing approach has missed the opportunity to sell product P at price points below PP1. The retailer loses potential revenue that could have been earned at lower price points.

Now consider demand curve 148 in FIG. 11b with multiple price points PP1, PP2, and PP3 each capable of generating a profit for the retailer. The number of price points that can be assigned on demand curve 148 differs by as little as one cent, or a fraction of a cent. With a consumer targeted marketing approach, those consumers with a purchasing decision threshold of PP1 will buy product P at that price, those consumers with a purchasing decision threshold of PP2 will buy product P at that price, and those consumers with a purchasing decision threshold of PP3 will buy product P at that price. The retailer now has the potential revenue of PP1*US1+PP2*US2+PP3*US3. Although the profit margins for price points PP2 and PP3 are less than price point PP1, the unit sales US2 and US3 will be greater than unit sales US1. The total revenue for the retailer under FIG. 1lb is greater than the revenue under FIG. 11a.

Under the consumer targeted marketing approach, each individual consumer receives a price point with an individualized discounted offer, i.e., PP1, PP2, or PP3, from the retailer for the purchase of product P. The individualized discounted offer is set according to the individual consumer price threshold that will trigger a positive purchasing decision for product P. The task is to determine an optimal pricing threshold for product P associated with each individual consumer and then make that discounted offer available for the individual consumer in order to trigger a positive purchasing decision. In other words, the individualized discounted offer involves consumer C1 being offered price PP1, consumer C2 being offered price PP2, and consumer C3 being offered price PP3 for product P. Each consumer C1-C3 should make the decision to purchase product P, albeit each with a separate price point set by the respective individualized discounted offer. Retailer service provider 72 makes possible the individual consumer targeted marketing with the consumer-specific, personalized “one-to-one” offers as a more effective approach for retailers to maximize revenue as compared to the same discounted price for every consumer under mass marketing. Retailer service provider 72 becomes the preferred source of retail information for the consumer, i.e., an aggregator of retailers capable of providing one-stop shopping for many purchasing options. The individualized discounted offers enable market segmentation to the “one-to-one” level with each individual consumer receiving personalized pricing for a specific product.

In order to generate the consumer model or comparative shopping service, personal assistant engine 74 must have access to comprehensive, reliable, and objective retailer product information. The retailer product information is combined with the consumer's profile and list of products of interest with weighted attributes from webpage 138 to generate optimized shopping list 140 for a specific consumer with individualized discounted offer 143 for each product on the list. Retailer service provider 72 maintains database 76 with up-to-date, comprehensive, reliable, and objective retailer product information. The product information includes the product description, product attributes, regular retail pricing, and discounted offers. Retailer service provider 72 must actively and continuously gather up-to-date product information in order to maintain database 76. In one approach to gathering product information, retailers 66-70 may grant access to T-LOG data 46 for use by retailer service provider 72. T-LOG data 46 collected during consumer check-out can be sent electronically from retailers 66-70 to retailer service provider 72, as shown by communication link 144 in FIG. 9. Retailers 66-70 may be reluctant to grant access to T-LOG data 46, particularly without quid pro quo. However, as retailer service provider 72 gains acceptance and consumers 62-64 come to rely on the service to make purchasing decisions, retailers 66-70 will be motivated to participate.

Assuming one or more retailers 66-70 choose to grant access to T-LOG data 46, the retailers may also define a maximum retailer acceptable discounted price for each product that can be used by retailer service provider 72 to trigger a positive purchasing decision by consumers 62-64. The maximum retailer acceptable discounted price is typically determined by the retailer's profit margin. If product P costs $1.50 to manufacture, distribute, and sell and the regular price is $2.50, then the retailer has at most $1.00 in profit to offer as a discount without creating an operating loss. In this case, the maximum retailer acceptable discounted price is $1.00 or less, depending on how much profit margin the retailer is willing to forego in order to make the sale.

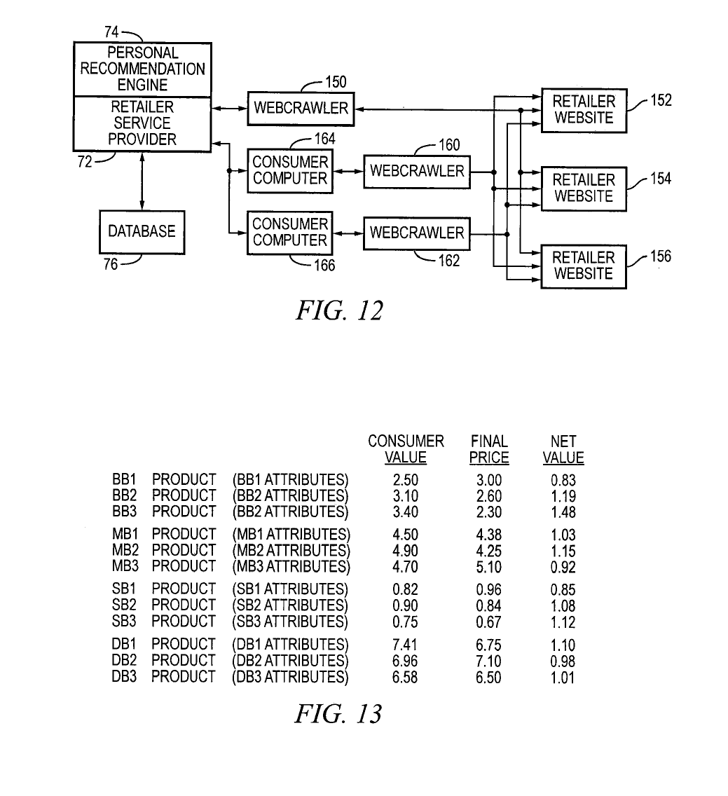

One or more retailers 66-70 may decline to provide access to its T-LOG data for use with personal assistant engine 74. In such cases, retailer service provider 72 can exercise a number of alternative data gathering approaches and sources. In one embodiment, retailer service provider 72 utilizes computer-based webcrawlers or other searching software to access retailer websites for pricing and other product information. In FIG. 12, webcrawler 150 operates within the software of computer systems 82, 90, 94, or 100 used by retailer service provider 72. Retailer service provider 72 dispatches webcrawler 150 to make requests for product information from websites or portals 152, 154, and 156 of retailers 66, 68, and 70, respectively. Webcrawler 150 collects and returns the product information to personal assistant engine 74 for storage within database 76. For example, webcrawler 150 identifies products available from each of retailer websites 152-156 and requests pricing and other product information for each of the identified products. Webcrawler 150 navigates and parses each page of retailer websites 152-156 to locate pricing and other product information. The parsing operation involves identifying and recording product description, universal product code (UPC), price, ingredients, size, and other product information as recovered by webcrawler 150 from retailer websites 152-156. In particular, the parsing operation can identify discounted offers and special pricing from retailers 66-70. The product information from retailer websites 152-156 is sorted and stored in database 76.

Retailer service provider 72 can also dispatch webcrawlers 160 and 162 from computers 164 and 166 used by consumers 62-64, or from consumer cell phone 86, or other electronic communication device, to access and request product information from retailer websites or portals 152-156 or other electronic communication medium or access point. During the registration process of FIG. 6, retailer service provider 72 acquires the IP address of consumer computers 164 and 166, as well as the permission of the consumers to utilize the consumer computer and login to access retailer websites 152-156. Retailer service provider 72 causes webcrawlers 160-162 to be dispatched from consumer computers 164-166 and uses the consumer login to retailer websites 152-156 to access and request product information from retailers 66-70. Webcrawlers 160-162 collect the product information from retailer websites 152-156 through the consumer computer and login and return the product information to personal assistant engine 74 for storage within database 76. The execution of webcrawlers 160-162 from consumer computers 164-166 distributes the computational work.

For example, retailer service provider 72 initiates webcrawler 160 in the background of consumer computer 164 with a sufficiently low execution priority to avoid interfering with other tasks running on the computer. The consumer can also define the time of day and percent or amount of personal computer resources allocated to the webcrawler. The consumer can also define which retailer websites and products, e.g., by specific retailer, market, or geographic region, that can be accessed by the webcrawler using the personal computer resources. Webcrawler 160 executes from consumer computer 164 and uses the consumer's login to gain access to retailer websites 152-156. Alternatively, webcrawler 160 resides permanently on consumer computer 164 and runs periodically. Webcrawler 160 identifies products available from each of retailer websites 152-156 and requests pricing and other product information for each of the identified products. Webcrawler 160 navigates and parses each page of retailer websites 152-156 to locate pricing and other product information. The parsing operation involves identifying and recording product description, UPC, price, ingredients, size, and other product information as recovered by webcrawler 160 from retailer websites 152-156. In particular, the parsing operation can identify discounted offers and special pricing from retailers 66-70. The product information from retailer websites 152-156 is sorted and stored in database 76.

Likewise, webcrawler 162 uses consumer computer 166 and login to gain access to retailer websites 152-156. Webcrawler 162 identifies products available from each of retailer websites 152-156 and requests pricing and other product information for each of the identified products. Webcrawler 162 navigates and parses each page of retailer websites 152-156 to locate pricing and other product information. The parsing operation involves identifying and recording product description, UPC, price, ingredients, size, and other product information as recovered by webcrawler 162 from retailer websites 152-156. In particular, the parsing operation can identify discounted offers and special pricing from retailers 66-70. The product information from retailer websites 152-156 is sorted and stored in database 76. The product information requests to retailer websites 152-156 can be specific to the consumer's login. Retailers 66-70 are likely to accept product information requests from webcrawlers 160-162 because the requests originate from consumer computers 164-166 by way of the consumer login to retailer websites 152-156.

Retailer service provider 72 can also collect product information from discounted offers transmitted from retailers 66-70 directly to consumers 62-64, e.g., by email or cell phone 66. Consumer 62-64 can make the personalized discounted offers and other product information available to retailer service provider 72.

With respect to pricing, each retailer has two price components: regular price and individualized discounted offers from the regular price that are variable over time and specific to each consumer. The net price to consumer 62 is the regular price less the individualized discounted offer for that consumer. To determine optimal individualized discount needed to achieve a positive consumer purchasing decision for product P from consumer 62, personal assistant engine 74 considers the individualized discounts from each retailer 66-70. In one embodiment, the individualized discount can be a default discount determined by the retailer or personal assistant engine 74 on behalf of the retailer. The default discount is defined to provide a reasonable profit for the retailer as well as reasonable likelihood of attaining the first position on optimized shopping list 140, i.e., the default discounted offer is selected to be competitive with respect to other retailers.

FIG. 13 shows three possible choices for the consumer requested bread product from retailers 66-70, as ascertained from database 76. Bread brand BB1 from retailer 66 is shown with BB1 product attributes, e.g., small loaf, not whole grain, 3 day freshness, and discounted price of $3.00 (regular price of $4.00 less 1.00 default discounted offer from retailer 66). The “Consumer Value” column shows the value to consumer 62 based on alignment of the BB1 product attributes and the weighted product attributes as defined by the consumer. The BB1 product gets attributes points AP1 for small loaf, no attributes points AP2 for not being whole grain, attribute points AP3 for 3 day freshness, and attributes points AP4 for the $3.00 discounted price. The consumer value (CV) is summation of assigned attributes points for alignment between the product attributes and the weighted product attributes as defined by the consumer times the preference level (normalized to 10) for the weighted product attributes, i.e., AP1*0.7+AP2*0.6+AP3*0.8+AP4*0.3. Assume that the BB1 product gets CV of $2.50 USD. The consumer value CV is given in a recognized monetary denomination, such as US dollar (USD), Canadian dollar, Australian dollar, Euro, British pound, Deutsche mark, Japanese yen, and Chinese yuan.

Consumer value CV can also be determined by equation (1) as follows:

CV=CV_{b}øₐ(Mₐ) (1)

where:
CV_{b} is a baseline product value of the product category, and
Mₐ is the product attribute value to the consumer for product attribute a expressed as (1+x %), where x is a percentage increase in value of the product to the consumer having the attribute a with respect to products having no product attribute a.

The “Final Price” column shows the final price (FP) offered to the consumer, i.e., regular price less the default discount from retailer 66 ($4.00−1.00=3.00). The “Net Value” column is the net value or normalized value (NV) of the BB1 product to consumer 62. In one embodiment, the net value is the consumer value normalized by the final price, i.e., NV=CV/FP. Alternatively, the net value is determined by NV=(CV-FP)/CV. Using the first normalizing definition, NV=2.50/3.00=0.83. The consumer value CV is less than the final price FP offered by retailer 66, including the default discount. The net value NV to consumer 62 is less than one so the BB1 product will not be a good choice for the consumer. Using the second normalizing definition, NV=(2.50−3.00)/2.50=−0.20. The net value NV to consumer 62 is negative so the BB1 product will not be a good choice for the consumer. Consumer 62 is unlikely to buy the BB1 product because the product attributes do not align or match well with the weighted consumer attributes, taking into account the individualized discounted offer. A net value NV less than one or negative indicates that retailer 66 is not even close to receiving a positive purchasing decision from consumer 62. Personal assistant engine 74 should not recommend the BB1 product to consumer 62 in optimized shopping list 140.

Bread brand BB2 from retailer 68 is shown with BB2 product attributes, e.g., not small loaf, whole grain, 2 day freshness, and pricing of $2.60 (regular price of $3.25 less 0.65 discounted offer from retailer 68). The BB2 product gets no attributes points AP5 for not being a small loaf, attributes points AP6 for whole grain, attribute points AP7 for 2 day freshness, and attributes points AP8 for the $2.60 price. The consumer value is AP5*0.7+AP6*0.6+AP7*0.8+AP8*0.3. Assume that the BB2 product gets CV of $3.10 USD. The final price FP is the regular price less the default discount from retailer 68 ($3.25−0.65=2.60). Using the first normalizing definition, NV=3.10/2.60=1.19. The net value NV to consumer 62 is greater than one so the BB2 product is a possible choice for the consumer. Using the second normalizing definition, NV=(3.10−2.60)/3.10=+0.16. The net value NV to consumer 62 is positive so the BB2 product is a possible choice for the consumer.

Bread brand BB3 from retailer 70 is shown with BB3 product attributes, e.g., small loaf, whole grain, 1 day freshness, and pricing of $2.30 (regular price of $3.20 less 0.90 discounted offer from retailer 70). The BB3 product gets attributes points AP9 for small loaf, attributes points AP10 for whole grain, attribute points AP11 for 1 day freshness, and attributes points AP12 for the $2.40 price. The consumer value is AP9*0.7+AP10*0.6+AP11*0.8+AP12*0.3. Assume that the BB3 product gets CV of $3.40 USD. The final price FP is the regular price less the default discount ($3.20−0.90=2.30). Using the first normalizing definition, NV=3.40/2.30=1.48. The net value NV to consumer 62 is greater than one so the BB3 product is a possible choice for consumer 62. Using the second normalizing definition, NV=(3.40−2.30)/3.40=+0.32. The net value NV to consumer 62 is positive so the BB3 product is a possible choice for the consumer. In fact, based on the default discounted offer from retailers 66-70, the net value of the BB3 product (NV=1.48) is higher than the net value of the BB2 product (NV=1.19) or BB1 product (NV=0.83). The BB3 product is placed on optimized shopping list 140.

In another embodiment, multiple brands and/or retailers for a single product can be placed on optimized shopping list 140. Personal assistant engine 74 can place say the top two or two three net value brands and/or retailers on optimized shopping list 140 and allow the consumer to make the final selection and purchasing decision. In the above example, the BB3 product could be placed in first position on optimized shopping list 140 and the BB2 product would be in second position on the optimized shopping list.

Under the consumer targeted marketing approach, each individual consumer receives a price point with an individualized discounted offer, i.e., PP1, PP2, or PP3, from the retailer for the purchase of product P. The individualized discounted offer is set according to the individual consumer price threshold that will trigger a positive purchasing decision for product P. The task is to determine an optimal pricing threshold for product P associated with each individual consumer and then make that discounted offer available for the individual consumer in order to trigger a positive purchasing decision. In other words, the individualized discounted offer involves consumer C1 being offered price PP1, consumer C2 being offered price PP2, and consumer C3 being offered price PP3 for product P. Each consumer C1-C3 should make the decision to purchase product P, albeit, each with a separate price point set by an individualized discounted offer. Retailer service provider 72 makes possible the individual consumer targeted marketing with the consumer-specific, personalized “one-to-one” offers as a more effective approach for retailers to maximize revenue as compared to the same discounted price for every consumer under mass marketing. Retailer service provider 72 becomes the preferred source of retail information for the consumer, i.e., an aggregator of retailers capable of providing one-stop shopping for many purchasing options. The individualized discounted offers enable market segmentation to the “one-to-one” level with each individual consumer receiving personalized pricing for a specific product.

The optimized individualized discounted offer is in part a competitive process between retailers. Since the consumer needs to purchase the product from someone, the price tipping point for consumers may involve a comparison of the best available price from competing retailers. In a variation of the previous example, the optimal individualized discounted offer needed to achieve a positive consumer purchasing decision for the product from consumer 62 involves a repetitive process beginning with the regular price, or regular price less the default discount, and then incrementally increasing the individualized discounted offer until the optimal individualized discount or winning retailer is determined. Continuing from the example of FIG. 13, retailer 66 offering bakery brand BB1 currently in second position behind retailer 70 offering bakery brand BB3 and may want to be in first position on optimized shopping list 140. Retailer 66 authorizes personal assistant engine 74 to increase the individualized discounted offer to consumer 62 as necessary to achieve that position. Personal assistant engine 74 increases the individualized discounted offer from retailer 66 by as little as one cent, or fraction of one cent, and recalculates the net value NV to consumer 62. If retailer 66 remains in second position, the discounted offer is incremented again and the net value NV is recalculated. The incremental increases in the individualized discounted offer from retailer 66 continue until retailer 66 achieves first position over retailer 70 on optimized shopping list 140, or until retailer 66 reaches its maximum retailer acceptable discount. The maximum retailer acceptable discounted price is typically determined by the retailer's profit margin. If product P costs $1.50 to manufacture, distribute, and sell, and the regular price is $2.50, then the retailer has at most $1.00 in profit to offer as a discount without creating an operating loss. In this case, the maximum retailer acceptable discounted price is $1.00 or less, depending on how much profit margin the retailer is willing to forego in order to make the sale. In most cases, retailer 66 will not exceed its maximum retailer acceptable discount, as to do so would result in no profit or a loss on the transaction.

If personal assistant engine 74 begins with the regular price for each retailer 66-70, the net value NV is determined for the bakery brand BB1-BB3 products based on the final price FP equal to the regular price for the respective products. The occurrence of a net value NV less than one or negative for particular retailers is not dispositive as the individualized discounted offers have not yet been considered. Personal assistant engine 74 may run the net value calculations based on the regular price to determine the retailer with the highest net value NV for consumer 62. The highest net value retailer based on the regular price is tentatively in first position, although the discounted offer optimization process is just beginning. Personal assistant engine 74 makes a first individualized discounted offer on behalf of each retailer 66-70 and calculates the net value NV for consumer 62, as described above, for each of the bakery brand BB1-BB3 products. The initial individualized discounted offer can be the default discount for the retailer, or a smaller incremental discount as little as one cent or fraction of one cent. Based on the initial individualized discounted offer, one retailer is determined to provide the highest net value NV for consumer 62. The individualized discounted offer optimization may stop there and the winning retailer will be in first position on optimized shopping list 140. Alternatively, retailers 66-70 authorize personal assistant engine 74 to increment their respective individualized discounted offer to consumer 62. The retailers that did not attain the coveted first position on optimized shopping list 140 after the initial individualized discount may want to continue bidding for that spot. Those retailers that choose to can incrementally increase their respective individualized discounted offer and personal assistant engine 74 recalculates the net value NV to consumer 62, as described above. Based on the revised individualized discounted offer, one retailer is determined to provide the highest net value NV for consumer 62 and will assume or retain first position on optimized shopping list 140.

In another example, the optimal individualized discount needed to achieve a positive consumer purchasing decision for the product from consumer 62 involves a repetitive process beginning with the regular price less the maximum retailer acceptable discount and then incrementally decreasing the individualized discounted offer, i.e., raising the final price FP for the product, until the optimal individualized discount is determined. In this case, assume personal assistant engine 74 begins with the regular price less the maximum retailer acceptable discount for each retailer 66-70. The net value NV is determined for the bakery brand BB1-BB3 products, as described above, based on the final price FP equal to the regular price less the maximum retailer acceptable discount for the respective products. The highest net value retailer based on the regular price less the maximum retailer acceptable discount is tentatively in first position.

Retailers 66-70 do not necessarily want to offer every consumer 62-64 the maximum retailer acceptable discount as that would minimize profit for the retailer. Personal assistant engine 74 must determine the price tipping point for consumer 62 to make a positive purchasing decision, i.e., the lowest individualized discounted price that would entice the consumer to purchase one product. Any product with a net value less than one or negative net value given the maximum retailer acceptable discount is eliminated because there is no practical discount, i.e., a discount that still yields a profit for the retailer, that the retailer could offer which would entice consumer 62 to purchase the product. As for the other products, personal assistant engine 74 incrementally modifies the individualized discounted offer to a value less than the maximum retailer acceptable discount, i.e., raises the final price FP (regular price minus the individualized discount) to consumer 62. The modified individualized discounted offer can be a lesser incremental discount, e.g., the default discount or as little as one cent or fraction of one cent less than the maximum retailer acceptable discount. Personal assistant engine 74 recalculates the net value NV for consumer 62, as described above, for each of the remaining bakery brand BB1-BB3 products (except for eliminated products) at the modified final price point. Based on the modified individualized discounted offer, one retailer is determined to provide the highest net value NV greater than one or positive for consumer 62. The highest net value retailer based on the regular price less the modified individualized discounted offer moves into or retains first position.

In each of the above examples of determining net value for consumer 62, multiple brands and/or retailers for a single product can be placed on optimized shopping list 140. Personal assistant engine 74 can place, say the top two or top three net value brands and/or retailers on optimized shopping list 140, and allow the consumer to make the final selection and purchasing decision.

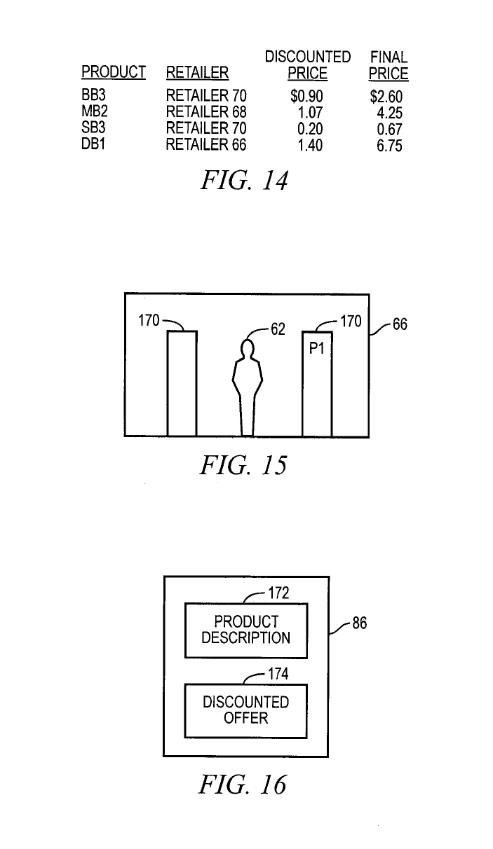

The above process is repeated for milk brands MB1, MB2, and MB3, canned soup brands SB1, SB2, and SB3, and detergent brands DB1, DB2, and DB3 based on the product information in database 76, preference levels for the weighted consumer product attributes, and lowest individualized discount that will result in a positive purchasing decision. The best value product brand for consumer 62 is placed on optimized shopping list 140. FIG. 14 shows optimized shopping list 140 containing the BB3 product from retailer 70 (NV=1.48), MB2 product from retailer 68 (NV=1.15), the SB3 product from retailer 70 (NV=1.12), and the DB1 product from retailer 66 (NV=1.10) are determined to be the best value product brand for consumer 62 and are placed on optimized shopping list 140. The other products from retailers 66-70 had a net value less than one or a net value greater than one but less than that of the winning retailer. The optimized shopping list 140 gives consumer 62 the ability to evaluate one or more recommended products each with an individualized discount customized for consumer 62 to make a positive purchasing decision.

The consumer patronizes retailers 66-70, either in person or on-line, with optimized shopping list 140 and individualized discounted offers 143 from personal assistant engine 74 in hand and makes purchasing decisions based on the recommendations on the optimized shopping list. Based on optimized shopping list 140, consumer 62 patronizes retailer 70 for the bakery brand BB3 product, retailer 68 for the milk brand MB2 product, retailer 70 for the canned soup brand SB3 product, and retailer 66 for the detergent brand DB1 product.

Personal assistant engine 74 helps consumers 62-64 quantify and evaluate, from a myriad of potential products on the market from competing retailers, a smaller, optimized list objectively and analytically selected to meet their needs while providing the best net value. The optimized shopping list 140 gives consumer 62 the ability to evaluate one or more recommended products or product families, each with an individualized discount customized for consumer 62 to make a positive purchasing decision. The consumers can rely on personal assistant engine 74 as having produced a comprehensive, reliable, and objective shopping list in view of the consumer's profile and weighted product preferences, as well as retailer product information, that will yield the optimal purchasing decision to the benefit of the consumer. The individualized discounted price should be set to trigger the purchasing decision. Personal assistant engine 74 helps consumers quantify and develop confidence in making a good decision to purchase a particular product or product family from a particular retailer at the individualized “one-to-one” discounted offer 143. While the consumer makes the decision to place the product in the basket for purchase, he or she comes to rely upon or at least consider the recommendations from retailer service provider 72, i.e., optimized shopping list 140 and individualized discounted offers 143 contributes to the tipping point for consumers to make the purchasing decision. The consumer model generated by personal assistant engine 74 thus in part controls many of the purchasing decisions and other aspects of commercial transactions within commerce system 60.

Another optimized shopping list 140 is generated for consumer 64 by repeating the above process using the preference levels for the weighted product attributes as defined by consumer 64. The optimized shopping list 140 for consumer 64 gives the consumer the ability to evaluate one or more recommended products each with an individualized discount customized for consumer 64 to make a positive purchasing decision. The discounted offer is individualized for each specific consumer 62-64 in that the discount is determined according to the individual consumer price threshold that will trigger a positive purchasing decision for that consumer. The recommended products are objectively and analytically selected from a myriad of possible products from competing retailers according to the consumer weighted attributes. Consumers 62-64 will develop confidence in making a good decision to purchase a particular product from a particular retailer.

Consumers 62-64 can also identify as a preference level assigned attribute a specific preferred retailer based on convenience and personal experience. The consumer may assign value to shopping with a specific retailer because of specific products offered by that store, familiarity with the store layout, good consumer service experiences, or location that is convenient on the way home from work, picking up the children from school, or routine weekend errand route.

Retailers 66-70 will want to show up as the recommended source for as many products as possible on optimized shopping list 140. Primarily, a particular retailer will be the optimized product source when the combination of the individualized discounted price and product attributes offered by the retailer aligns with, or provides maximum net value for the consumer in accordance with, the consumer's profile and shopping list with weighted preferences. Retailers 66-70 can enhance their relative position and provide support for retailer service provider 72 by making T-LOG data 46 available to retailer service provider 72. One way to get a high score when comparing retailer product attributes to the consumer-defined weighted product attributes is to ensure that personal assistant engine 74 has access to the most accurate and up-to-date retailer product attributes via database 76. Even though a given retailer may have a desirable product attribute, personal assistant engine 74 cannot record a high score if it does not have complete information about the retailer's products. By giving retailer service provider 72 direct access to T-LOG data 46, the retailer makes the product information readily available to personal assistant engine 74 which will hopefully increase its score and provide more occurrences of the retailer as the recommended source for as many products as possible on the optimized shopping list. While the use of webcrawlers in FIG. 12 is effective in gathering product information from retailer websites, direct access to retailer T-LOG data 46 will further aid the consumers in generating optimized shopping list 140.

The optimized shopping list 140 with individualized discounts can be transferred from consumer computers 164-166 to cell phone 86. Consumers 62-64 patronize retailers 66-70 each with optimized shopping list 140 from personal assistant engine 74 in hand and make purchasing decisions based on the recommendations on the optimized shopping list. The individualized discounted prices are conveyed to retailers 66-70 by electronic communication from cell phone 86 to the retailer's check-out register. The discounted pricing can also be conveyed from consumer computer 164-166 directly to retailers 66-70 and redeemed with a retailer loyalty card assigned to the consumer. Retailers 66-70 will have a record of the discounted offers and the loyalty card will match the consumer to the discounted offers on file. In any case, consumers 62-64 each receive an individualized discounted offer as set by personal assistant engine 74.

The consumers can rely on personal assistant engine 74 as having produced a comprehensive, reliable, and objective shopping list in view of the consumer's profile and preference level for each weighted product attribute, as well as retailer product information and individualized discount, that will yield the optimal purchasing decision for the benefit of the consumer. Personal assistant engine 74 helps consumers 62-64 quantify and evaluate, from a myriad of potential products on the market from competing retailers, a smaller, optimized list objectively and analytically selected to meet their needs while providing the best net value. Consumers 62-64 will develop confidence in making a good decision to purchase a particular product from a particular retailer. While the consumer makes the decision to place the product in the basket for purchase, he or she comes to rely upon, or at least consider, the recommendations from retailer service provider 72, i.e., optimized shopping list 140 with the embedded individualized discount contributes to the tipping point for consumers to make the purchasing decision. The consumer model generated by personal assistant engine 74 thus in part controls many of the purchasing decisions and other aspects of commercial transactions within commerce system 60.

The purchasing decisions actually made by consumers 62-64 while patronizing retailers 66-70 can be reported back to retailer service provider 72. Upon completing the check-out process, the consumer is provided with an electronic receipt of the purchases made. The electronic receipt is stored in cell phone 86, downloaded to personal assistant engine 74, and stored in database 76 for comparison to optimized shopping list 140. The actual purchasing decisions made when patronizing retailers 66-70 may or may not coincide with the preference levels or weighted attributes assigned by the consumer when constructing the original shopping list. For example, in choosing the canned soup, consumer 62 may have decided at the time of making the purchasing decision that one product attribute, e.g., product ingredients, was more important than another product attribute, e.g., brand. Consumer 62 made the decision to deviate from optimized shopping list 140, based on product ingredients, to choose a different product than the one recommended on the optimized shopping list. Personal assistant engine 74 can prompt consumer 62 for an explanation of the deviation from optimized shopping list 140, i.e., what product attribute became the overriding factor at the moment of making the purchasing decision. Personal assistant engine 74 learns from the actual purchasing decisions made by consumer 62 and can update the preference levels of the consumer weighted product attributes. The preference level for product ingredients can be increased and/or the preference level for brand can be decreased. The revised preference levels for the consumer weighted product attributes will improve the accuracy of subsequent optimized shopping lists. The pricing and other product information uploaded from cell phone 86 after consumer check-out to personal assistant engine 74 can also be used to modify the product information, e.g., pricing, in database 76.

Consumers 62-64 can also utilize personal assistant engine 74 without a product of interest necessarily being on optimized shopping list 140. Consider an example of consumer 62 patronizing the store of retailer 66 with optimized shopping list 140. FIG. 15 shows consumer 62 physically on the premises of retailer 66 proximate to shelves 170 containing product P1. Many cell phones 86 are capable of scanning the UPC by taking a picture of the barcode and transmitting the picture to retailer service provider 72 for decoding. A mobile app on cell phone 86 can also decode the barcode into the UPC. Consumer 62 can take a photo of the barcode of product P1 of interest using cell phone 86. The photo is transmitted to personal assistant engine 74. Personal assistant engine 74 reviews the consumer weighted attributes for that product and determines the individualized discounted offer available from the retailer for that consumer. If there is no consumer weighted attributes on file for the product of interest, then personal assistant engine 74 can offer a default individualized discount determined by the personal assistant engine and/or the retailer. A product description 172 and individualized discounted offer 174 are transmitted back to the consumer and displayed on cell phone 86, as shown in FIG. 16. The consumer can make the purchasing decision at that moment with knowledge of the available individualized discounted offer 174. With the benefits of personal assistant engine 74, consumers 62-64 need no longer pay the stated regular shelf price for virtually any product. Consumers 62-64 can receive an individualized discounted offer 174 for any product at any time.

Retailer service provider 72 can also make available discounts, promotions, and special offers for products that retailers 66-70 want to advertise or promote. Retailer service provider 72 matches the promoted products to consumer preferences in database 76. Consumers that may have an interest or need for the promoted products receive product description 172 and discounted offer 174 on cell phone 86, as described in FIG. 16.

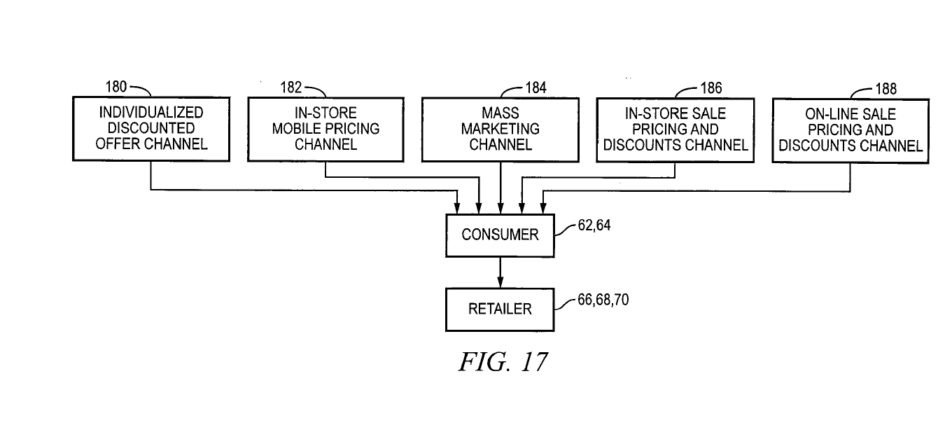

FIG. 17 illustrates a variety of marketing channels for use by retailers 66-70 to increase sales and revenue and maximize profit. The individualized discounted offer channel 180 has been described in FIGS. 9-14. The in-store mobile pricing channel 182 has been described in FIGS. 15-16. Mass marketing channel 184 involves general distribution of discounted offers, promotions, and advertisements, such as sale prices and coupons sent by mail or email, publicly distributed flyers, billboards, sponsored public events, and public media (newspaper, magazines, television, radio). In-store sale prices and discounts channel 186 are displayed on the shelves or end-caps of the retailer proximate to the associated product or otherwise displayed in a visible location for the consumer. For example, the retailer can post a sale price adjacent to the product or display a promotional sign in a window. On-line sale prices and discounts channel 188 are published on retailer websites 152-156, as described in FIG. 12. For example, the retailer can present a sale price or discount adjacent to the product on a webpage of the retailer website. Marketing channels 180-188 are made available to consumers 62-64 to entice a purchasing decision. Consumers 62-64 patronize retailers 66-70 and purchase one or more products based in part on the sale price, discounted offer, promotion, and advertisement presented by marketing channels 180-188.

Retailers 66-70 regularly evaluate how to optimize marketing strategies and allocate marketing budgets, i.e., offer discounts and promotions, to each of the marketing channels 180-188. In many cases, different people or organizations within retailers 66-70 are responsible for different marketing approaches. For example, one person or department within retailer 66 is responsible for individualized discounted offers channel 180. A different person or department within retailer 66 is responsible for mass marketing channel 184. Yet another person or department within retailer 66 is responsible for website 152 and on-line sale pricing and discounts channel 188. Within the enterprise level planning of the retailer, each marketing channel 180-188 will be allowed to offer discounts and promotions in order to increase sales and revenue based on the allocation of the overall marketing budget to each marketing channel. The enterprise level generally refers to a view of the organization of the retailer as a whole. The goal is to optimize enterprise level profit for the retailer as a whole. Each marketing channel 180-188 executes within its marketing approach and according to the enterprise level planning to maximize enterprise level profit.

Retailer service provider 72 can create a hierarchical cross marketing channel optimization to assist retailers 66-70 with maximizing enterprise level profit. The hierarchical cross marketing channel optimization determines how to allocate the enterprise marketing budget to individual marketing channels 180-188 that allows each marketing channel to offer discounts and promotions in accordance with its allocation or portion of the enterprise marketing budget. Alternatively, retailers 66-70 can create the hierarchical cross marketing channel optimization without using retailer service provider 72.

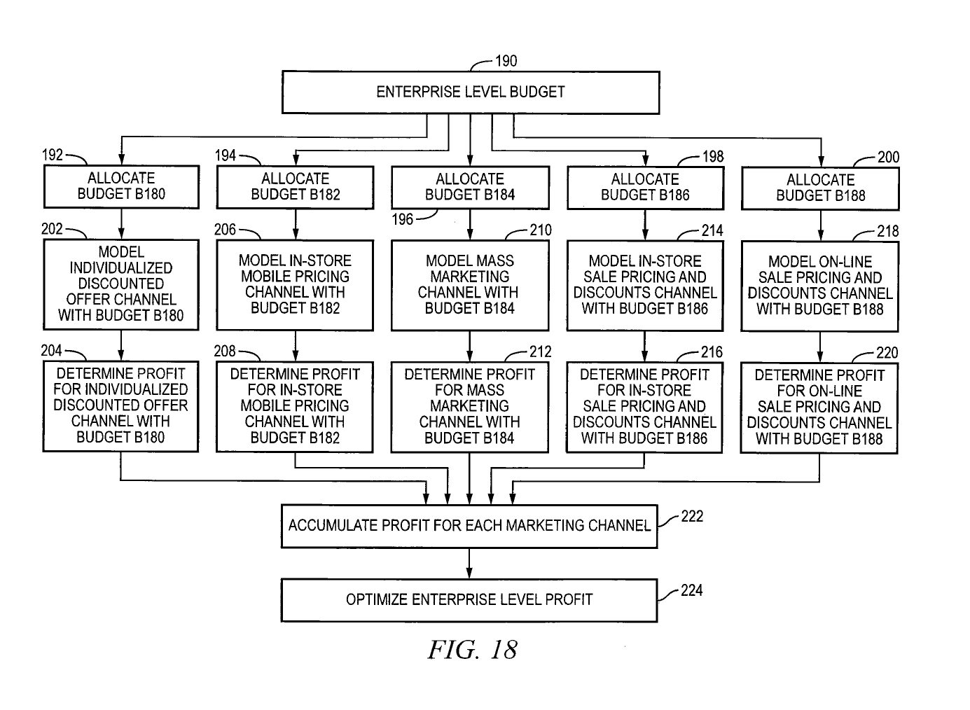

In one embodiment, retailer 66 projects an enterprise level marketing budget 190 in FIG. 18. The individualized discounted offer channel 180 is allocated a portion B₁₈₀ of budget 190 in block 192; in-store mobile pricing channel 182 is allocated a portion B₁₈₂ of budget 190 in block 194; mass marketing channel 184 is allocated a portion B₁₈₄ of budget 190 in block 196; in-store sale prices and discounts channel 186 is allocated a portion B₁₈₆ of budget 190 in block 198; on-line sale prices and discounts channel 188 is allocated a portion B₁₈₈ of budget 190 in block 200. The allocation of budgets B₁₈₀-B₁₈₈ for marketing channels 180-188 allows each marketing channel to offer discounts and promotions and engage in advertising. Each marketing channel 180-188 is modeled to determine sales, revenue, and profit based on the budgets B₁₈₀-B₁₈₈. The modeling can be a demand model based on variable pricing, see FIGS. 11a-11b. For example, a price point PP1 for a product is selected and demand US1 is determined for the selected price point PP1 in accordance with a marketing channel being modeled. The revenue for the product under the marketing channel is PP1*US1. The profit for the products sold under the marketing channel is revenue less costs, i.e., US1*(PP1−cost per unit). The cost within the marketing channel being modeled includes inventory, raw materials, labor, facilities, equipment, taxes, marketing, and other overhead expenses.

More specifically, the individualized discounted offer channel 180 is modeled for a plurality of price points and projected demand for each product to be discounted based on budget B₁₈₀ in block 202. The profit for each selected price point and projected demand for each product under the individualized discounted offer channel 180 with budget B₁₈₀ is determined in block 204. The in-store mobile pricing channel 182 is modeled for a plurality of price points and projected demand for each product to be discounted based on budget B₁₈₂ in block 206. The profit for each selected price point and projected demand for each product under the in-store mobile pricing channel 182 with budget B₁₈₂ is determined in block 208. The mass marketing channel 184 is modeled for a plurality of price points and projected demand for each product to be discounted based on budget B₁₈₄ in block 210. The profit for each selected price point and projected demand for each product under the in-store mobile pricing channel 184 with budget B₁₈₄ is determined in block 212. The in-store sale pricing and discounts channel 186 is modeled for a plurality of price points and projected demand for each product to be discounted based on budget B₁₈₆ in block 214. The profit for each selected price point and projected demand for each product under the in-store sale pricing and discounts channel 186 with budget B₁₈₆ is determined in block 216. The on-line sale pricing and discounts channel 188 is modeled for a plurality of price points and projected demand for each product to be discounted based on budget B₁₈₉ in block 218. The profit for each selected price point and projected demand for each product under the on-line sale pricing and discounts channel 188 with budget B₁₈₈ is determined in block 220.

The profits for marketing channels 180-188 is accumulated in block 222. In one embodiment, the individual profits for marketing channels 180-188 are summed for total profit. The enterprise level profit is then optimized in block 224. For example, the enterprise level profit 224 is optimized when the sum of the individual profits from marketing channels 180-188 has been maximized. To maximize the sum of the individual profits from marketing channels 180-188, the allocation of enterprise level marketing budget 190 to individual budgets B₁₈₀-B₁₈₈ is adjusted based on performance of marketing channels 180-188. The performance of marketing channels 180-188 can be the individual profits normalized to the respective budgets B₁₈₀-B₁₈₈. The profit from block 204 divided by budget B₁₈₀ is representative of the return on the marketing investment in the individualized discounted offer channel 180. Likewise, the profit from block 208 divided by budget B₁₈₂; the profit from block 212 divided by budget B₁₈₄; the profit from block 216 divided by budget B₁₈₆; the profit from block 220 divided by budget B₁₈₈ are each representative of the return on the respective marketing investment for marketing channels 182-188.

If the normalized profit for individualized discounted offer channel 180 is higher than the normalized profit for mass marketing channel 184, then the budget B₁₈₀ can be increased and budget B₁₈₄ can be decreased. In general, the budgets for the better performing marketing channels are increased and the budgets for the lesser performing marketing channels are decreased. The modeling and profit of marketing channels 180-188 in blocks 202-220 is executed again and the individual profits are accumulated in block 222. The enterprise level profit 224 under the revised budget allocations B₁₈₀-B₁₈₈ is compared to the enterprise level profit under the previous budget allocations B₁₈₀-B₁₈₈. If the enterprise level profit under the revised budget allocations B₁₈₀-B₁₈₈ is greater than the enterprise level profit under the previous budget allocations B₁₈₀-B₁₈₈, then the budget reallocations B₁₈₀-B₁₈₈ have moved toward or achieved an optimized enterprise level profit. The allocation of enterprise level marketing budget 190 to individual budgets B₁₈₀-B₁₈₈ is again adjusted based on performance of marketing channels 180-188, i.e., by reviewing the individual profits from blocks 204, 208, 212, 216, and 220 normalized to the revised budget allocations B₁₈₀-B₁₈₈. The budgets for the better performing marketing channels are increased and the budgets for the lesser performing marketing channels are decreased. The modeling and profit of marketing channels 180-188 in blocks 202-220 is reexecuted and the individual profits are accumulated in block 222. The enterprise level profit 224 under the second revised budget allocations B₁₈₀-B₁₈₈ is compared to the enterprise level profit under the first revised budget allocations B₁₈₀-B₁₈₈. If the enterprise level profit under the revised budget allocations B₁₈₀-B₁₈₈ is greater than the enterprise level profit under the previous budget allocations B₁₈₀-B₁₈₈, then the second budget allocations B₁₈₀-B₁₈₈ have moved toward or achieved an optimized enterprise level profit. The process repeats until the budget allocations B₁₈₀-B₁₈₈ that achieve a maximum enterprise level profit 224.

The comparisons between performance of marketing channels 180-188 can be performed individually or collectively. Two or more marketing channels can be grouped and compared against a target baseline objective performance or other individual marketing channels or groups of marketing channels.

In another modeling scenario, the budget allocation for a lesser performing marketing channel is increased to see if more marketing dollars improves the performance, i.e., increases the normalized profit of the lesser performing marketing channel or increases enterprise level profit 224. Likewise, the budget allocation for a higher performing marketing channel is decreased to see if less marketing dollars improves the performance, i.e., increases the normalized profit of the higher performing marketing channel or increases enterprise level profit 224.

In another modeling scenario, the budget allocation for one marketing channel is ramped from a small value or zero to a high value, while the budget allocations for the other marketing channels are held constant, to observe the performance the one marketing channel under different budget allocation, as well as enterprise level profit 224. The enterprise marketing budget 190 is increased in steps to permit higher budget allocations for the one marketing channel without taking from the other marketing channels. In a similar manner, the budget allocations for two or more marketing channels are ramped from a small value or zero to a high value, while the budget allocations for the other marketing channels are held constant, to observe the performance the two or more marketing channels under different budget allocation, as well as enterprise level profit 224.

In yet another modeling scenario, the enterprise level budget 190 is increased or decreased and each marketing channel is repeatedly adjusted based on normalized profit from the individual marketing channels, as described above, to observe enterprise level profit 224.

The optimization of enterprise level profit 224 also takes into account cannibalization and affinity between marketing channels 180-188. If one marketing channel detracts from another marketing channel, then the overall effect is observable in enterprise level profit 224. For example, increasing the on-line sale pricing and discounts marketing channel 188 may reduce in-store sale pricing and discounts marketing channel 184. Retailers 66-70 can evaluate the cross marketing effects to optimize enterprise level profit 224.

In general, hierarchical cross marketing channel optimization allows each marketing channel to be modeled and evaluated under a variety of scenarios to observe the effect on enterprise level profit 224. The budgets B₁₈₀-B₁₈₈ can be increased or decreased individually or in groups and the enterprise level budget 190 can be increased or decreased, to optimize the enterprise level profit 224.

The optimal enterprise level profit 224 is not necessarily the maximum profit. In some cases, the enterprise level profit 224 is optimized according to the strategic business plan of the retailer. For example, if the business plan of the retailer involves moving in the direction of more individualized discounted offers and less mass marketing, then budget B₁₈₀ for the individualized discounted offer channel 180 is held to an artificially higher value than its current performance would justify while budget B₁₈₄ for mass marketing channel 184 is held to a lower value than its current performance would indicate to follow the strategic business plan of the retailer. The enterprise level profit 224 is less than could be otherwise achieved, but the retailer is willing to accept less profit in the short term to achieve its the strategic business plan. Likewise, if the business plan of the retailer involves moving in the direction of more on-line business, then budget B₁₈₈ for the on-line sale pricing and discounts channel 188 is held to an artificially higher value than its current performance would justify while budgets B₁₈₀-B₁₈₆ for marketing channels 180-186 are held to a lower value than current performance would indicate to follow the strategic business plan of the retailer. The enterprise level profit 224 is less than could be otherwise achieved, but the retailer is willing to accept less profit in the short term to achieve its strategic business plan.

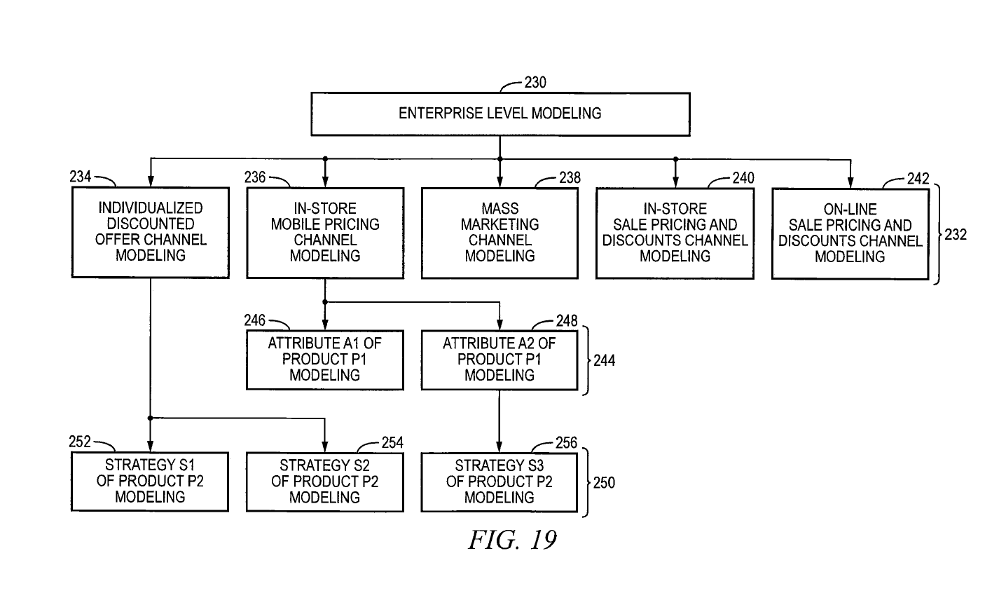

The modeling activities for retailers 66-70 are organized in a hierarchical manner, as shown in FIG. 19. That is, the modeling activities occur at different levels of the retailer's organization. Enterprise level modeling and optimization is performed in block 230 to optimize overall profit or other strategic objective for the retailer. A second modeling level 232 includes individualized discounted offer channel modeling in block 234, in-store mobile pricing channel modeling in block 236, mass marketing channel modeling in block 238, in-store sale pricing and discounts channel modeling in block 240, and on-line sale pricing and discounts channel modeling in block 242, as described in FIG. 18. The cross channel marketing optimization is represented by blocks 234-242 in modeling level 232. A third modeling level 244 under in-store mobile pricing channel modeling 236 includes attribute A1 of product P1 modeling in block 246 and attribute A2 of product P1 modeling in block 248. In one embodiment, attribute modeling involves optimization of pricing based on consumer-defined preferences for product attributes to reach a purchasing decision by the consumer, as described in FIGS. 13-14. The attribute modeling level 244 can be performed under any one or more of the marketing channel modeling 232-242. A fourth modeling level 250 under individualized discounted offer channel modeling 234 includes strategy S1 of product P2 modeling in block 252 and strategy S2 of product P2 modeling in block 254. Strategy S3 of product P2 modeling in block 256 occurs under attribute A2 of product P1 modeling in block 248. In one embodiment, strategy S1 modeling involves price optimization for maximum profit, and strategy S2 price optimization for maximum revenue. Strategy S3 modeling involves demand optimization for maximum market share. The strategy modeling level 250 can be performed under any one or more of the marketing channel modeling 232-242, or any one or more of the attribute modeling 246-248. Attribute modeling level 244 can be a lower modeling level than strategy modeling level 250.

The hierarchical modeling levels 230, 232, 244, and 250 allow retailers 66-70 to perform lower level modeling according to a variety of parameters and combine the lower level modeling results in a hierarchical manner to achieve enterprise level optimization. Each modeling level 230, 232, 244, and 250 can be evaluated, adjusted, and re-executed to an optimal outcome. For example, strategy S1 is modeled in block 252 for a price that achieves maximum profit for product P2. The price optimization for product P2 from block 252 is routed to marketing channel modeling 234-242 to determine the most effective manner to relay a discount or promotion to the consumer that conveys the optimized price to the consumer. The individual marketing channel modeling results are routed to enterprise level marketing 230 to confirm the pricing strategy to achieve maximum profit for the retailer, taking into account all operational levels of the organization. In a similar manner, strategy S3 is modeled in block 256 for a demand that achieves maximum market share for product P2. The demand optimization for product P2 from block 256 is routed to attribute modeling level 244 to determine the consumer or class of consumer most likely to purchase the product. The attribute modeling level results are routed to marketing channel modeling 234-242 to determine the most effective manner to relay the suggested product to the consumer. The in-store mobile pricing marketing channel modeling results are routed to enterprise level marketing 230 to confirm the demand strategy to achieve maximum market share for the retailer, taking into account all operational levels of the organization.

By combining the lower modeling levels in a hierarchical manner, the effect of individual lower level modeling on the enterprise level strategic planning can be observed, confirmed, and implemented in the business plan of the retailer for optimal commercialization of the product. An outcome from a lower level modeling is used to execute a higher level modeling. The outcome of the higher level modeling can be used to adjust the lower level model. The different marketing levels of retailers 66-70 can be modeled, evaluated, adjusted, and integrated to achieve enterprise level optimization for the retailer. The enterprise level optimization allows retailers 66-70 to implement specific marketing strategies that influence consumer purchasing decisions and control movement of goods within commerce system 60.

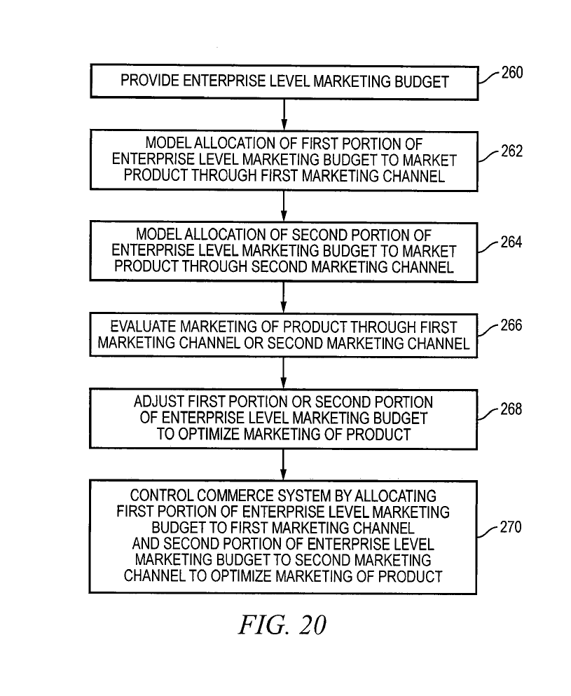

FIG. 20 illustrates a process for controlling a commerce system by allocating the first portion of the enterprise level marketing budget to the first marketing channel and the second portion of the enterprise level marketing budget to the second marketing channel to optimize the marketing of the product. In step 260, an enterprise level marketing budget is provided. In step 262, an allocation of a first portion of the enterprise level marketing budget is modeled to market a product through a first marketing channel. In step 264, an allocation of a second portion of the enterprise level marketing budget is modeled to market the product through a second marketing channel. The first marketing channel and second marketing channel include an individualized discounted offer channel, in-store mobile pricing channel, mass marketing channel, in-store sale prices and discounts channel, or on-line sale prices and discounts channel. In step 266, the marketing of the product is evaluated through the first marketing channel or second marketing channel. Profit for the product marketed is evaluated through the first marketing channel and second marketing channel and normalized based on a respective portion of the enterprise level marketing budget allocated to the marketing channel. The marketing of the product through the first marketing channel and second marketing channel can be evaluated collectively. In step 268, the first portion or second portion of the enterprise level marketing budget is adjusted to optimize the marketing of the product. The enterprise level marketing budget can be adjusted to optimize the marketing of the product. In step 270, the commerce system is controlled by allocating the first portion of the enterprise level marketing budget to the first marketing channel and the second portion of the enterprise level marketing budget to the second marketing channel to optimize the marketing of the product.

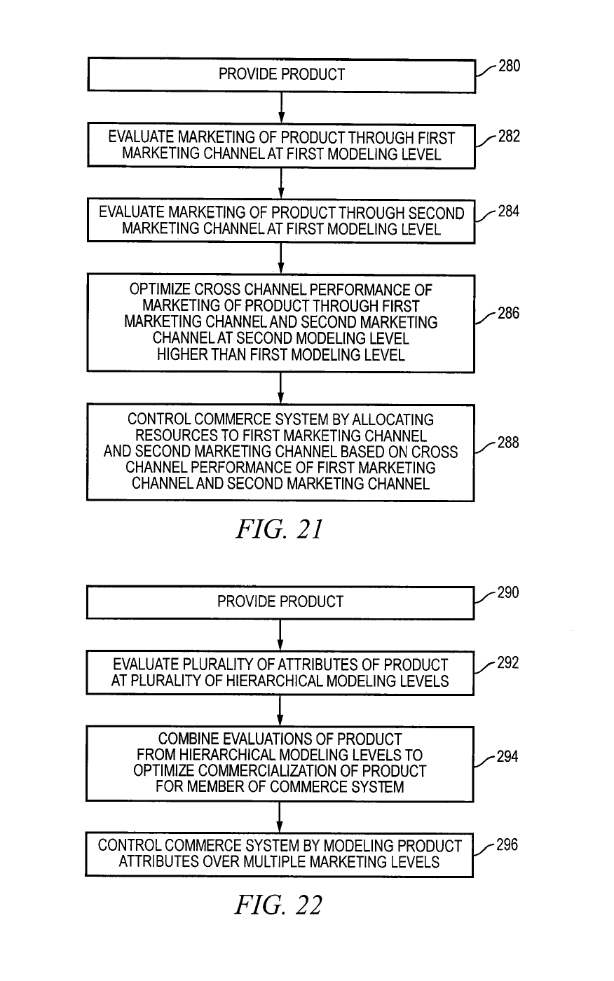

FIG. 21 illustrates another process for controlling a commerce system by allocating resources to the first marketing channel and second marketing channel based on the cross channel performance of the first marketing channel and second marketing channel. In step 280, a product is provided. In step 282, the marketing of the product is evaluated through a first marketing channel at a first modeling level. In step 284, the marketing of the product is evaluated through a second marketing channel at the first modeling level. The first marketing channel and second marketing channel include an individualized discounted offer channel, in-store mobile pricing channel, mass marketing channel, in-store sale prices and discounts channel, or on-line sale prices and discounts channel. An attribute of the product can be modeled at a third modeling level lower than the second modeling level. Profit for the product marketed through the first marketing channel and second marketing channel is evaluated. In step 286, cross channel performance of the marketing of the product through the first marketing channel and second marketing channel is optimized at a second modeling level higher than the first modeling level. The second modeling level can be an enterprise modeling level. In step 288, controlling the commerce system is controlled by allocating resources to the first marketing channel and second marketing channel based on the cross channel performance of the first marketing channel and second marketing channel.

FIG. 23 illustrates another process for controlling a commerce system by modeling product attributes over multiple modeling levels. In step 290, a product is provided. In step 292, a plurality of attributes of the product is evaluated at a plurality of hierarchical modeling levels. The hierarchical modeling levels include an enterprise level modeling, cross channel marketing level modeling, product attribute level modeling, and product strategy level modeling. The marketing of the product through a first marketing channel is evaluated at a first modeling level. The marketing of the product through a second marketing channel is evaluated at the first modeling level. The cross channel marketing level modeling includes an individualized discounted offer channel, in-store mobile pricing channel, mass marketing channel, in-store sale prices and discounts channel, and on-line sale prices and discounts channel. In step 294, the evaluations of the product from the hierarchical modeling levels are combined to optimize commercialization of the product for a member of the commerce system. Cross channel performance of the marketing of the product through the first marketing channel and second marketing channel is optimized at a second modeling level higher than the first modeling level. An outcome from a lower level modeling can be used to execute a higher level modeling. The lower level modeling is adjusted based on a higher level modeling. In step 296, the commerce system is controlled by allocating resources to the first marketing channel and second marketing channel based on the cross channel performance of the first marketing channel and second marketing channel.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
providing an enterprise level marketing budget;
modeling allocation of a first portion of the enterprise level marketing budget to market a product through a first marketing channel;
modeling allocation of a second portion of the enterprise level marketing budget to market the product through a second marketing channel;
evaluating the marketing of the product through the first marketing channel or second marketing channel;
adjusting the first portion or second portion of the enterprise level marketing budget to optimize the marketing of the product; and
controlling the commerce system by allocating the first portion of the enterprise level marketing budget to the first marketing channel and the second portion of the enterprise level marketing budget to the second marketing channel to optimize the marketing of the product.

2. The method of claim 1, wherein the first marketing channel and second marketing channel are selected from a group consisting of an individualized discounted offer channel, in-store mobile pricing channel, mass marketing channel, in-store sale prices and discounts channel, and on-line sale prices and discounts channel.

3. The method of claim 1, wherein evaluating the marketing of the product includes evaluating profit for the product marketed through the first marketing channel and second marketing channel.

4. The method of claim 3, further including normalizing the profit for the product based on a portion of the enterprise level marketing budget allocated to a marketing channel.

5. The method of claim 1, further including adjusting the enterprise level marketing budget to optimize the marketing of the product.

6. The method of claim 1, further including evaluating the performance of marketing the product through the first marketing channel and second marketing channel collectively.

7. A method of controlling a commerce system, comprising:
providing a marketing budget;
providing a product;
evaluating marketing of the product through a first marketing channel at a first modeling level in accordance with the marketing budget;
evaluating marketing of the product through a second marketing channel at the first modeling level in accordance with the marketing budget; and
optimizing cross channel performance of the marketing of the product through the first marketing channel and second marketing channel at a second modeling level.

8. The method of claim 7, further including controlling the commerce system by allocating resources to the first marketing channel and second marketing channel based on the cross channel performance of the first marketing channel and second marketing channel.

9. The method of claim 7, further including:
allocating a first portion of the marketing budget to market the product through the first marketing channel;
allocating a second portion of the marketing budget to market the product through the second marketing channel; and
adjusting the first portion or second portion of the marketing budget to optimize the marketing of the product.

10. The method of claim 7, wherein the first marketing channel and second marketing channel are selected from a group consisting of an individualized discounted offer channel, in-store mobile pricing channel, mass marketing channel, in-store sale prices and discounts channel, and on-line sale prices and discounts channel.

11. The method of claim 7, further including evaluating profit for the product marketed through the first marketing channel and second marketing channel.

12. The method of claim 7, wherein the second modeling level includes an enterprise modeling level.

13. The method of claim 7, further including modeling an attribute of the product at a third modeling level lower than the second modeling level.

14. A method of controlling a commerce system, comprising:
providing a marketing budget;
providing a product;
evaluating marketing of the product through a first marketing channel in accordance with the marketing budget;
evaluating marketing of the product through a second marketing channel in accordance with the marketing budget; and
optimizing cross channel performance of the marketing of the product through the first marketing channel and second marketing channel.

15. The method of claim 14, further including:
evaluating the marketing of the product through the first marketing channel at a first modeling level;
evaluating the marketing of the product through the second marketing channel at the first modeling level; and
optimizing the cross channel performance of the marketing of the product through the first marketing channel and second marketing channel at a second modeling level higher than the first modeling level.

16. The method of claim 14, further including controlling the commerce system by allocating resources to the first marketing channel and second marketing channel based on the cross channel performance of the first marketing channel and second marketing channel.

17. The method of claim 14, further including:
allocating a first portion of the marketing budget to market the product through the first marketing channel;
allocating a second portion of the marketing budget to market the product through the second marketing channel; and
adjusting the first portion or second portion of the marketing budget to optimize the marketing of the product.

18. The method of claim 14, wherein the cross channel marketing level modeling includes an individualized discounted offer channel, in-store mobile pricing channel, mass marketing channel, in-store sale prices and discounts channel, and on-line sale prices and discounts channel.

19. The method of claim 14, further including evaluating profit for the product marketed through the first marketing channel and second marketing channel.

20. The method of claim 14, wherein the second modeling level includes an enterprise modeling level.

21. A computer program product usable with a programmable computer processor having a computer readable program code embodied in a tangible computer usable medium for controlling a commerce system, comprising:
providing a marketing budget;
providing a product;
evaluating marketing of the product through a first marketing channel in accordance with the marketing budget;
evaluating marketing of the product through a second marketing channel in accordance with the marketing budget; and
optimizing cross channel performance of the marketing of the product through the first marketing channel and second marketing channel.

22. The computer program product of claim 21, further including:
evaluating the marketing of the product through the first marketing channel at a first modeling level;
evaluating the marketing of the product through the second marketing channel at the first modeling level; and
optimizing the cross channel performance of the marketing of the product through the first marketing channel and second marketing channel at a second modeling level higher than the first modeling level.

23. The computer program product of claim 21, further including controlling the commerce system by allocating resources to the first marketing channel and second marketing channel based on the cross channel performance of the first marketing channel and second marketing channel.

24. The computer program product of claim 21, further including:
allocating a first portion of the marketing budget to market the product through the first marketing channel;
allocating a second portion of the marketing budget to market the product through the second marketing channel; and
adjusting the first portion or second portion of the marketing budget to optimize the marketing of the product.

25. The computer program product of claim 21, wherein the cross channel marketing level modeling includes an individualized discounted offer channel, in-store mobile pricing channel, mass marketing channel, in-store sale prices and discounts channel, and on-line sale prices and discounts channel.
